(19) United States
(12) Patent Application Publication
(10) Pub. No.: US 2001/0043043 A1
(43) Pub. Date: Nov. 22, 2001

(54) Organic electroluminescent display panel and organic electroluminescent device used therefor

(76) Inventors: Megumi Aoyama, Tokyo (JP); Mutsuko Nakano, Tokyo (JP); Michio Arai, Tokyo (JP); Hiroshi Yamamoto, Tokyo (JP)

Correspondence Address: Pamela G. Maher, Brown Raysman Millstein Felder & Steiner LLP, Suite 711, 1880 Century Park East, Los Angeles, CA, 90067, US

(21) Appl. No.: 09/755,446

(22) Filed: Jan. 6, 2001

(30) Foreign Application Priority Data
Jan. 7, 2000 (JP) 2000-001368
Jan. 7, 2000 (JP) 2000-001369
Aug. 29, 2000 (JP) 2000-259433

(51) Int. Cl. H05B 33/00

(52) U.S. Cl. 313/506; 427/66

(57) ABSTRACT

An organic EL display panel includes a substrate, an organic light emitting layer between two electrodes, one of which is transparent, and a color filter layer formed by evaporating a pigment and/or an organic dye, the organic EL display panel being divided into a plurality of organic EL devices capable of being independently controlled. The organic EL display panel having such constitution can be manufactured at low cost and made thinner, and has excellent properties.

### BACKGROUND OF THE INVENTION

The present invention relates to an organic EL (electroluminescent) display panel and an organic electroluminescent device therefor, and in particular, to such an organic EL display panel and an organic EL device therefor which can be manufactured at low cost and made thinner, and has excellent properties.

### DESCRIPTION OF THE PRIOR ART

In recent years, organic EL devices have been under intensive investigation.

The organic EL device comprises, as basic components, a hole injecting electrode such as a tin-doped indium oxide (ITO) electrode, a hole transporting material layer formed on the hole injecting electrode and containing a triphenyldiamine or the like, an organic light emitting layer laminated on the hole transporting material layer and containing a fluorescent material such as an aluminum quinolinol complex (Alq3), and a metal electrode (electron injecting electrode) formed of a metal having a low work function such as magnesium. Such an organic EL device is characterized in that it can achieve a very high luminance ranging from a few hundred to tends of thousands of cd/m² with a driving voltage of approximately 10 volts.

An organic EL display panel using such an organic EL device can be expected to find applications in various display apparatuses, particularly in a color display apparatuses.

When an organic EL display panel is applied as a color display apparatus, it is common procedure to form light emitting layers each for emitting light of the three primary colors, red, green and blue, for each pixel, or to form a plurality of light emitting layers and color filter layers and obtain light of the three primary colors, red, green and blue, from white light emitted from the plurality of light emitting layers for each pixel using the color filter layers. Further, it is also known to combine fluorescence converting layers for absorbing light of a specific wavelength, color filter layers and light emitting layers for emitting light whose intensity peak lies at a specific wavelength, thereby obtaining light of red, green and blue for each pixel.

However, when light emitting layers for emitting light of the three primary colors, red, green and blue, are formed for each pixel, there are problems in that it is difficult to obtain red light having a high color purity since few fluorescent materials suitable for a light emitting layer for emitting red light are available and that the lifetime of a color display apparatus depends upon that of a light emitting layer for emitting blue light because the lifetime of the light emitting layer for emitting blue light is extremely short in comparison with those of light emitting layers for emitting red light and green light.

To the contrary, when a color display apparatus is constructed by forming a plurality of light emitting layers for emitting white light and color filter layers and obtaining light of the three primary colors, red, green or blue (R, G, B), for each pixel using the color filter layers or when a color display apparatus is constructed by using a light emitting layer for emitting monochromatic light in combination with a fluorescence converting layer formed of a fluorescent material and adapted for converting light emitted from the light emitting layer into light of a specific color and a color filter layer, a color display apparatus can be simply constructed at low cost using only a single organic EL device and, therefore, is suitable for a practical use.

Conventionally, the color filter layer is formed on a substrate using a photo-lithographic process. However, color resist material is expensive and in the case where the color filter layer is formed using a photo- lithographic process, after resist layers corresponding to red, green and blue colors are formed and exposed to light, they have to be subjected to development processing for removing unnecessary portions therefrom. Furthermore, since layers formed by a photo-lithographic process and patterned contain a volatile solvent, they have to be subjected to heat treatment for removing the volatile solvent therefrom. As a result, the number of steps has to be increased and the time required for manufacturing the color filter layers inevitably becomes longer. Therefore, it is difficult to manufacture a color display panel at low cost when the color filter layers are formed using a photo-lithographic process.

Moreover, when color filter layers are formed on a substrate using a photo-lithographic process, since the thickness of the color filter layers may differ greatly between the color filter layers for the respective colors, of R, G and B, it is necessary to provide overcoat layers thereon to compensate for the difference in thickness between the color filter layers for the respective colors, R, G and B. However, since the thickness of the color filter layers formed by a photo-lithographic process normally ranges from 0.1 to 2.0 μm and the thickness of the overcoat layers is about 3.5 μm, while the thickness of a transparent electrode and auxiliary hard wiring formed on the color filter layers is about 0.1 μm, if the color filter layers and the overcoat layers are not uniformly formed, there is considerable risk of the transparent electrode and auxiliary hard wiring formed on the color filter layers being cut. Therefore, it is sometimes difficult to form hard wiring in a desired manner to achieve an organic EL display panel.

Further, when color filter layers are formed on a substrate using a photo-lithographic process, it is indispensable to remove unnecessary portions of resist layers by exposure and development. However, since a wall is formed at the edge of the color filter layer at more than 50 degrees therewith unless the exposure is performed for a sufficiently long time, there is also considerable risk of the transparent electrode and auxiliary hard wiring being cut at these portions. To the contrary, if the exposure is carried out for a sufficiently long time, manufacturing cost has to be increased.

In addition, as a result of removing a volatile solvent by heat treatment, the surface of the layer becomes uneven and this causes light to be unevenly emitted, thereby degrading the organic EL display panel.

In the case where a fluorescence converting layer is provided for absorbing light emitted from light emitting layer so that phosphors contained therein are excited by absorbed light energy, thereby emitting light, similar problems arise.

### SUMMARY OF THE INVENTION

It is therefore an object of the present invention to provide an organic EL display panel and an organic EL device therefor which can be manufactured at low cost and made thinner, and has excellent properties.

The inventors of the present invention conducted a study for accomplishing the above object of the present invention and, as a result, found that the above object of the present invention can be accomplished by an organic EL display panel comprising a substrate, at least one organic light emitting layer between two electrodes, at least one of which is transparent, and a color filter layer formed by evaporating a pigment and/or an organic dye, the organic EL display panel being divided into a plurality of organic EL devices capable of being independently controlled.

According to the present invention, since a color filter layer is formed by evaporating a pigment and/or an organic dye without using any expensive color resist material containing resins and photosensitive components in addition to pigment, it is possible to manufacture an organic EL display panel at much lower cost than in the case of an organic EL display panel including a color filter layer formed by a photo-lithographic process.

Further, according to the present invention, since a color filter layer can be formed by only forming evaporation layers for the primary colors using a mask such as a metal mask, a shadow mask or the like, it is unnecessary to expose and develop the respective resist layers for the primary colors and it is also unnecessary to remove a volatile solvent and the like from the layers after patterning so that the number of steps is markedly reduced as compared with the case where a color filter layer is formed by a photo-lithographic process. Therefore, since time required for manufacturing an organic EL display panel can be markedly reduced, the cost of manufacturing an organic EL display panel can be considerably reduced.

Furthermore, according to the present invention, since a color filter layer is formed by evaporating a pigment and/or an organic dye, the thickness of the color filter layer can be markedly reduced, thereby enabling the overall thickness of the organic EL display panel to be considerably reduced.

Moreover, according to the present invention, since a color filter layer is formed by evaporating a pigment and/or an organic dye, the thickness of the color filter layer can be markedly reduced. Therefore, since no overcoat layer is needed, the transparent electrode and auxiliary hard wiring formed on the color filter layers can be reliably prevented from being cut due to fluctuation in thickness of the color filter layers and the overcoat layers.

Further, according to the present invention, when a color filter layer is formed by evaporating a pigment and/or an organic dye, the angle of walls formed at edges of color filter layers can be restricted within a few degrees by evaporating a pigment and/or an organic dye using a mask, such as a metal mask, a shadow mask or the like, so as to wrap around from the gap between the mask, such as a metal mask, a shadow mask or the like, and the surface onto which evaporation is performed, such as the surface of a substrate, onto the surface onto which evaporation is performed, such as the surface of the substrate. Therefore, the transparent electrode and auxiliary hard wiring formed on the color filter layers can be reliably prevented from being cut.

Furthermore, according to the present invention, since a patterned layer does not contain any volatile solvent and it is unnecessary to remove any volatile solvent from the layer after patterning, it is possible to prevent the surface of a color filter layer from becoming uneven and light from being unevenly emitted. Further, it is possible to minimize the influence on electrodes or an organic light emitting layer due to unevenness of a color filter layer.

Moreover, according to the present invention, since a color filter layer is formed by evaporating a pigment and/or an organic dye, a color filter layer can be formed on a substrate having relatively low heat resistance, such as a film, and, therefore, it is possible to improve the degree of freedom in selecting a substrate material.

In a preferred aspect of the present invention, an organic EL display panel further includes a fluorescence converting layer for converting light emitted from the at least one organic light emitting layer into light of a predetermined wavelength on the color filter layer on the side of the two electrodes.

According to this preferred aspect of the present invention, since the organic EL display panel further includes a fluorescence converting layer for converting light emitted from the at least one organic light emitting layer into light of a predetermined wavelength, it is possible to generate light components of wavelengths which are not contained in light emitted from the at least one organic light emitting layer or to compensate light with a light emitted from the at least one organic light emitting layer with light components of wavelengths which are not sufficiently contained therein.

In a further preferred aspect of the present invention, the fluorescence converting layer is formed by evaporating a fluorescent substance.

According to this preferred aspect of the present invention, since the fluorescence converting layer is formed by evaporating a fluorescent substance, it is possible to markedly reduce the thickness of the fluorescence converting layer compared with that of a fluorescence converting layer formed by a photo-lithographic process, thereby enabling the thickness of the organic EL display panel to be markedly reduced.

In a further preferred aspect of the present invention, the substrate is formed of a transparent substrate and the two electrodes are composed of a transparent hole injecting electrode and an electron injecting electrode and the organic EL display panel includes the color filter layer, the hole injecting layer, the at least one organic light emitting layer and the electron injecting electrode on the substrate in this order.

In a further preferred aspect of the present invention, the organic EL display panel further includes a fluorescence converting layer for converting light emitted from the at least one organic light emitting layer into light of a predetermined wavelength on the color filter layer on the side of the hole injecting electrode.

In another preferred aspect of the present invention, the two electrodes are composed of a transparent hole injecting electrode and an electron injecting electrode and the organic EL display panel includes the electron injecting electrode, the at least one organic light emitting layer, the hole injecting layer and the color filter layer on the substrate in this order.

In a further preferred aspect of the present invention, the organic EL display panel further includes a fluorescence converting layer for converting light emitted from the at least one organic light emitting layer into light of a predetermined wavelength on the color filter layer on the side of the hole injecting electrode.

In another preferred aspect of the present invention, the substrate is formed of a transparent substrate, the two electrodes are composed of a transparent hole injecting electrode and a transparent electron injecting electrode and the organic EL display panel includes the color filter layer on one surface of the substrate and includes the hole injecting layer, the at least one organic light emitting layer and the electron injecting electrode on the other surface of the substrate in this order.

In a further preferred aspect of the present invention, the organic EL display panel further includes a fluorescence converting layer for converting light emitted from the at least one organic light emitting layer into light of a predetermined wavelength on the one surface of the substrate and the fluorescence converting layer is disposed on the color filter layer on the side of the substrate.

In another preferred aspect of the present invention, the organic EL display panel further includes a fluorescence converting layer for converting light emitted from the at least one organic light emitting layer into light of a predetermined wavelength on the other surface of the substrate and the fluorescence converting layer is disposed between the electrode and the substrate.

The above object of the present invention can also be accomplished by an organic EL display device comprising a substrate, at least one organic light emitting layer between two electrodes, at least one of which is transparent, and a color filter formed by evaporating a pigment and/or an organic dye.

According to the present invention, since a color filter is formed by evaporating a pigment and/or an organic dye without using an expensive color resist material containing resins and photosensitive components in addition to pigment, it is possible to manufacture an organic EL display panel at much lower cost than in the case of an organic EL display panel including a color filter formed by a photo-lithographic process.

Further, according to the present invention, since a color filter can be formed by only forming evaporation layers for the primary colors using a mask, such as a metal mask, a shadow mask or the like, it is unnecessary to expose and develop the respective resist layers for the primary colors and it is also unnecessary to remove a volatile solvent and the like from the layers after patterning, so that the number of steps is markedly reduced as compared with the case where a color filter is formed by a photo-lithographic process. Therefore, since the time required for manufacturing an organic EL display panel can be markedly reduced, the cost of manufacturing an organic EL display panel can be greatly reduced.

Furthermore, according to the present invention, since a color filter is formed by evaporating a pigment and/or an organic dye, the thickness of the color filter can be markedly reduced, thereby enabling the thickness of an organic EL display panel to be greatly reduced.

Moreover, according to the present invention, since a color filter is formed by evaporating a pigment and/or an organic dye, the thickness of the color filter can be markedly reduced. Therefore, since no overcoat layer is needed, the transparent electrode and auxiliary hard wiring formed on the color filter can be reliably prevented from being cut due to fluctuation in thickness of the color filters and the overcoat layers.

Further, according to the present invention, when a color filter is formed by evaporating a pigment and/or an organic dye, the angle of walls formed at edges of color filters can be restricted within a few degrees by evaporating a pigment and/or an organic dye using a mask, such as a metal mask, a shadow mask or the like, so as to wrap around from the gap between the mask, such as a metal mask, a shadow mask or the like, and the surface onto which evaporation is performed, such as the surface of a substrate onto the surface onto which evaporation is performed such as the surface of the substrate. Therefore, the transparent electrode and auxiliary hard wiring formed on the color filters can be reliably prevented from being cut.

Furthermore, according to the present invention, since a patterned layer does not contain any volatile solvent and it is unnecessary to remove any volatile solvent from the layer after patterning, it is possible to prevent the surface of a color filter from becoming uneven and light from being unevenly emitted. Further, it is possible to minimize the influence on electrodes or an organic light emitting layer due to unevenness of a color filter.

Moreover, according to the present invention, since a color filter is formed by evaporating a pigment and/or an organic dye, a color filter can be formed on a substrate having relatively low heat resistance, such as a film, and, therefore, it is possible to improve the degree of freedom in selecting a substrate material.

In a preferred aspect of the present invention, the color filter includes a first color filter, a second color filter and a third color filter formed adjacent to each other, the first color filter having a light transmittance property for transmitting light having a wavelength of 573 to 780 nm, the second color filter having a light transmittance property for transmitting light having a wavelength of 493 to 573 nm and the third color filter having a light transmittance property for transmitting light having a wavelength of 380 to 493 nm.

According to this preferred aspect of the present invention, since the color filter includes a first color filter, a second color filter and a third color filter formed to be adjacent to each other, the first color filter having a light transmittance property for transmitting light having a wavelength of 573 to 780 nm, the second color filter having a light transmittance property for transmitting light having a wavelength of 493 to 573 nm and the third color filter having a light transmittance property for transmitting light having a wavelength of 380 to 493 nm, irrespective of the wavelength of light emitted from an organic light emitting layer, an organic EL device can generate light of the primary colors, red, green and blue. Therefore, arbitrary colors can be displayed not only when an organic light emitting layer for emitting white light is employed but also when organic compounds capable of emitting light of a wavelength close to that of red, green or blue light with a high efficiency for a long time are employed, although the color purity of the light emitted from the organic compounds is low.

In a further preferred aspect of the present invention, the first color filter has a light transmittance property for transmitting light having a wavelength of 578 to 620 nm, the second color filter has a light transmittance property for transmitting light having a wavelength of 520 to 570 nm and the third color filter has a light transmittance property for transmitting light having a wavelength of 430 to 470 nm.

In another preferred aspect of the present invention, the color filter has a light transmittance property for transmitting light having a wavelength of 573 to 780 nm, a light transmittance property for transmitting light having a wavelength of 493 to 573 nm or a light transmittance property for transmitting light having a wavelength of 380 to 493 nm.

According to this preferred aspect of the present invention, since the color filter has a light transmittance property for transmitting light having a wavelength of 573 to 780 nm, a light transmittance property for transmitting light having a wavelength of 493 to 573 nm or a light transmittance property for transmitting light having a wavelength of 380 to 493 nm, light of one of the primary colors, red, green and blue, can be generated irrespective of the wavelength of light emitted from an organic light emitting layer and when an organic EL device is employed for a color display, a specific color can be displayed at a specific portion of the color display.

In a further preferred aspect of the present invention, the color filter has a light transmittance property for transmitting light having a wavelength of 578 to 620 nm, a light transmittance property for transmitting light having a wavelength of 520 to 570 nm or a light transmittance property for transmitting light having a wavelength of 430 to 470 nm.

In a further preferred aspect of the present invention, the at least one organic light emitting layer includes a first unit organic light emitting layer, a second unit organic light emitting layer and a third unit organic light emitting layer formed to be adjacent to each other, the first unit organic light emitting layer having a light emitting property for emitting light having a wavelength of 573 to 780 nm, the second unit organic light emitting layer having a light emitting property for emitting light having a wavelength of 493 to 573 nm and the third unit organic light emitting layer having a light emitting property for emitting light having a wavelength of 380 to 493 nm.

In a preferred aspect of the present invention, an organic EL device further includes a fluorescence converting layer for converting light emitted from the at least one organic light emitting layer into light of a predetermined wavelength on the color filter on the side of the two electrodes.

According to this preferred aspect of the present invention, since the organic EL device further includes a fluorescence converting layer for converting light emitted from the at least one organic light emitting layer into light of a predetermined wavelength, it is possible to generate light components of wavelengths which are not contained in light emitted from the at least one organic light emitting layer or to compensate light with a light emitted from the at least one organic light emitting layer with light components of wavelengths which are not sufficiently contained therein.

In a further preferred aspect of the present invention, the fluorescence converting layer is formed by evaporating a fluorescent substance.

According to this preferred aspect of the present invention, since the fluorescence converting layer is formed by evaporating a fluorescent substance, it is possible to markedly reduce the thickness of the fluorescence converting layer as compared with that of a fluorescence converting layer formed by a photo-lithographic process, thereby enabling the thickness of an organic EL device, and as a result, the thickness of an organic EL display panel, to be markedly reduced.

In a preferred aspect of the present invention, the substrate is formed as a transparent substrate, the two electrodes are composed of a transparent hole injecting electrode and an electron injecting electrode, and the organic EL device includes the color filter layer, the hole injecting layer, the at least one organic light emitting layer and the electron injecting electrode on the substrate in this order.

In a further preferred aspect of the present invention, the organic EL device further includes a fluorescence converting layer for converting light emitted from the at least one organic light emitting layer into light of a predetermined wavelength on the color filter layer on the side of the hole injecting electrode.

In another preferred aspect of the present invention, the two electrodes are composed of a transparent hole injecting electrode and an electron injecting electrode and the organic EL device includes the electron injecting electrode, the at least one organic light emitting layer, the hole injecting layer and the color filter on the substrate in this order.

In a further preferred aspect of the present invention, the organic EL device further includes a fluorescence converting layer for converting light emitted from the at least one organic light emitting layer into light of a predetermined wavelength on the color filter on the side of the hole injecting electrode.

In another preferred aspect of the present invention, the substrate is formed of a transparent substrate, the two electrodes are composed of a transparent hole injecting electrode and a transparent electron injecting electrode and the organic EL device includes the color filter on one surface of the substrate and includes the hole injecting layer, the at least one organic light emitting layer and the electron injecting electrode on the other surface of the substrate in this order.

In another preferred aspect of the present invention, the organic EL device further includes a fluorescence converting layer for converting light emitted from the at least one organic light emitting layer into light of a predetermined wavelength on the one surface of the substrate and the fluorescence converting layer is disposed on the color filter on the side of the substrate.

In another preferred aspect of the present invention, the organic EL device further includes a fluorescence converting layer for converting light emitted from the at least one organic light emitting layer into light of a predetermined wavelength on the other surface of the substrate and the fluorescence converting layer is disposed between the electrode and the substrate.

### BRIEF DESCRIPTION OF THE DRAWINGS

FIG. 1 is a schematic cross-sectional view showing an organic EL device which is a preferred embodiment of the present invention.

FIG. 2 is a schematic cross-sectional view showing an organic EL device which is another preferred embodiment of the present invention.

FIG. 3 is a schematic cross-sectional view showing an organic EL device which is a further preferred embodiment of the present invention.

FIG. 4 is a schematic cross-sectional view showing an organic EL device which is a further preferred embodiment of the present invention.

FIG. 5 is a schematic cross-sectional view showing an organic EL device which is a further preferred embodiment of the present invention.

FIG. 6 is a schematic cross-sectional view showing an organic EL device which is a further preferred embodiment of the present invention.

FIG. 7 is a schematic cross-sectional view showing an organic EL device which is a further preferred embodiment of the present invention.

### DESCRIPTION OF THE PREFERRED EMBODIMENTS

In the present invention, a pigment and/or an organic dye can be employed for forming a color filter layer or a color filter and either an inorganic pigment or an organic pigment can be used as the pigment. Examples of inorganic pigments usable for the present invention include metal complex oxides and the like and mixtures of inorganic pigments and organic pigments may be used.

Between pigments and organic dyes, organic pigments and organic dyes can be preferably used from the viewpoint of abundant color variation and between organic pigments and organic dyes, organic pigments are more preferable because they have high heat resistance and do not dissolved in organic solvent or water.

In the present invention, a color filter layer or a color filter is preferably formed by co-evaporating a pigment and an organic dye.

In the present invention, a color filter layer or a color filter is preferably formed by evaporating two or more kinds of pigments and/or two or more kinds of organic dyes. In the case where a color filter layer or a color filter is formed by evaporating two or more kinds of pigments and/or two or more kinds of organic dyes, it is possible to form a color filter layer or a color filter having a desired light transmittance property by selecting the two or more kinds of pigments and/or two or more kinds of organic dyes, and even when a green filter or the like which is hard to form by evaporating a single kind of a pigment or an organic dye is to be formed, it is possible to form a color filter layer or a color filter having a desired light transmittance property.

In the present invention, in the case where a color filter layer or a color filter is formed using two or more kinds of pigments and/or two or more kinds of organic dyes, it is preferable to individually control the temperature of the respective boards containing pigments and/or organic dyes and co-evaporate two or more kinds of pigments and/or two or more kinds of organic dyes, thereby forming a color filter layer or a color filter. In the case where two or more kinds of pigments and/or two or more kinds of organic dyes are co-evaporated, they can be simultaneously evaporated. Therefore, it is possible to shorten a processing time as compared with the case where two or more evaporation layers are formed and it is possible to form a color filter layer or a color filter containing two or more kinds of pigments and/or two or more kinds of organic dyes in a desired manner even when the respective vapor pressures of pigments and/or organic dyes differ greatly unlike the case where two or more kinds of pigments and/or two or more kinds of organic dyes are mixed and evaporated.

In the present invention, in the case where a color filter layer or a color filter is formed using two or more kinds of pigments and/or two or more kinds of organic dyes, it is possible to form two or more evaporation layers by respectively evaporating two or more kinds of pigments and/or two or more kinds of organic dyes and layer them, thereby forming a color filter layer or a color filter. In the case where a color filter layer or a color filter is formed by co-evaporating two or more kinds of pigments and/or two or more kinds of organic dyes, the amounts of the two or more kinds of pigments and/or two or more kinds of organic dyes to be added have to be accurately controlled and, therefore, the operation is complicated. To the contrary, in the case where two or more evaporation layers are formed by respectively evaporating two or more kinds of pigments and/or two or more kinds of organic dyes and layered, thereby forming a color filter layer or a color filter, it is possible to simply form a color filter layer or a color filter having a desired light transmittance property and even when the respective vapor pressures of pigments and/or organic dyes differ greatly, it is possible to simply form a color filter layer or a color filter having a desired light transmittance property.

Further, in the present invention, in the case where a color filter layer or a color filter is formed by evaporating two or more kinds of pigments and/or two or more kinds of organic dyes to form two or more evaporation layers and layering them, each evaporation layer may be formed by co-evaporating two or more kinds of pigments and/or two or more kinds of organic dyes.

In the present invention, a color filter layer or a color filter is preferably formed by mask-evaporating pigments and/or organic dyes using a mask such as a metal mask, a shadow mask or the like. In the case where a color filter layer or a color filter is formed by mask- evaporating pigments and/or organic dyes, a color filter layer or a color filter can be formed in a desired pattern.

Furthermore, if pigments and/or organic dyes are evaporated using a mask, such as a metal mask, a shadow mask or the like, so as to wrap around from the gap between the mask, such as a metal mask, a shadow mask or the like, and the surface onto which evaporation is performed such as a substrate surface, the angle of a wall formed at a boundary portion between a color filter layer or a color filter and an area where a color filter layer or a color filter is not formed can be controlled within a few degrees, thereby preventing a transparent electrode and auxiliary hard wiring to be formed on the color filter layer or the color filter from being cut.

In the present invention, conditions for evaporating pigments and/or organic dyes are not specifically limited but evaporation is preferably conducted under a pressure not greater than 1×10⁻⁴ Pa and at a rate of about 0.01 to 1 nm/second.

In the present invention, known materials can be used as organic pigments and organic dyes. Illustrative examples of organic pigments and organic dyes for red color include those of diketopyrrolopyrrole, anthraquinone, quinacridone, perylene, azo, and benzimidazolone type; illustrative examples of organic pigments and organic dyes for green color include those of copper halide phthalocyanine and anthraquinone type; and illustrative examples of organic pigments and organic dyes for blue color include those of copper phthalocyanine and indanthron type. Illustrative examples of organic pigments and organic dyes for yellow color obtained by mixing colors include those of isoindoline, isoindolinone, quinophtalone and disazo type, and illustrative examples of organic pigments and organic dyes for violet color include those of dioxazine and anthraquinone type.

Among these organic pigments and organic dyes, an organic pigment or an organic dye of azo type is preferably employed for forming a red color filter layer and an organic pigment or an organic dye of copper phthalocyanine type is preferably employed for forming a blue color filter layer. Further, a green and red filter layer is preferably formed by layering an evaporation layer of an organic pigment or an organic dye of copper phthalocyanine type and an evaporation layer of an organic pigment or an organic dye of disazo type, or by mixing an organic pigment or an organic dye of copper phthalocyanine type and an organic pigment or an organic dye of disazo type.

In the present invention, chromaticity improves with increasing thickness of a color filter layer or a color filter formed by evaporation, and if a color filter layer or a color filter formed by evaporation is too thin, the performance thereof declines. However, if a color filter layer or a color filter formed by evaporation is too thick, since pigment crystals appear or cracks occur in the color filter layer or the color filter, the thickness of a color filter layer or a color filter formed by evaporation is preferably equal to or less than 1.5 μm. More specifically, the preferable thickness of a color filter layer or a color filter depends upon the colors. A red color filter layer preferably has a thickness from 400 to 15000 angstrom. A green color filter layer preferably has a thickness obtained by layering a blue color evaporation layer having a thickness of 200 to 10000 angstrom and a blue color evaporation layer having a thickness of 1000 to 2000 angstrom and a blue color filter layer preferably has a thickness of 400 to 15000 angstrom. The thickness of the red color filter layer, the green color filter layer and the blue color filter layer may be varied depending upon the optical properties required.

In the present invention, a passivation layer is preferably formed on the surface of a color filter layer or a color filter. When a passivation layer is formed on the surface of a color filter layer or a color filter, it is possible to prevent the color filter layer or the color filter from being damaged by etching or cleaning effected for patterning an electrode and, therefore, to protect the color filter layer or the color filter.

In the case where a color filter layer or a color filter is formed on a hole injecting electrode, the passivation layer formed on the surface of the color filter layer or the color filter serves to protect an organic light emitting layer from a water component and gases and can serve as an isolation layer when a color filter layer or a color filter is conductive.

In the case where a color filter layer or a color filter is formed on the side surface of a substrate opposite to two electrodes, the passivation layer formed on the surface of the color filter layer or the color filter serves to prevent the color filter layer or the color filter from being damaged, thereby protecting it.

In the present invention, a fluorescence converting layer may be formed on the electrode side of a color filter layer or a color filter for converting light emitted from an organic light emitting layer into light having a predetermined wavelength and when a fluorescence converting layer is formed, a passivation layer may be formed on the surface of the fluorescence converting layer and/or the color filter layer or the color filter.

A fluorescence converting layer includes phosphor materials which can be stimulated by incident light from an organic light emitting layer, producing and emitting light having a wavelength different from that of the incident light. The phosphor materials are those for emitting lights having wavelengths determined by the energy level thereof and it is preferable to employ compounds for emitting fluorescent light corresponding to three primary colors, red, green and blue, as fluorescent materials contained in the fluorescence converting layer. Fluorescent materials can convert light of a short wavelength into light of a long wavelength and, therefore, light of arbitrary color (wavelength) can be produced by converting blue light into red, green and yellow lights.

In the present invention, illustrative examples of fluorescent substances preferably employed for a fluorescence converting layer include quinacridone, rubrene and styryl dyes disclosed in Japanese Patent Application Laid Open No. 63-264692 or at least one compound selected from a group consisting of coumarin, lumogene and the like. Further, metal complexes containing 8-quinolinol such as tris(8-quinolinolato) aluminum (Alq3) having the chemical structure shown below or derivatives thereof as ligands and fluorescent substances such as tetraphenylbutadiene, anthracene, perylene, coronene, 12-phthaloperinone derivatives and the like may be preferably used for a fluorescence converting layer. Moreover, phenylanthracene derivatives disclosed in Japanese Patent Application Laid Open No. 8-12600, tetraarylethene derivatives disclosed in Japanese Patent Application Laid Open No. 8-12969 and the like may be used as fluorescent substances for a fluorescence converting layer.

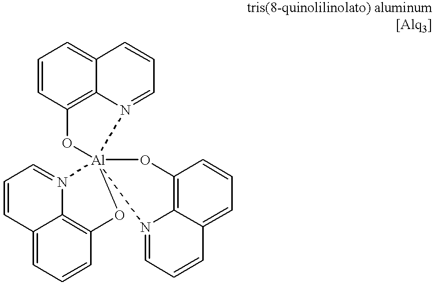

In the present invention, in the case where a fluorescence converting layer is formed, the fluorescence converting layer preferably has a thickness equal to or less than 2000 nm and more preferably from about 300 nm to about 600 nm.

Jn the present invention, in the case where a fluorescence converting layer is formed, the fluorescence converting layer is preferably formed by evaporating fluorescent materials.

In the present invention, a fluorescence converting layer may be formed by evaporating two or more kinds of fluorescent materials.

In the present invention, in the case where a fluorescence converting layer is formed by evaporating two or more kinds of fluorescent materials, it is preferable to form the fluorescence converting layer by individually controlling the temperature of each board containing a fluorescent material to co-evaporate two or more kinds of fluorescent materials. In the case where two or more kinds of fluorescent materials are co-evaporated, since they can be simultaneously evaporated, the processing time can be shortened as compared with the case where two or more evaporation layers are layered. Further, a fluorescence converting layer containing two or more kinds of fluorescent materials can be desirably formed even when vapor pressures of the respective fluorescent materials differ greatly, unlike the case where two or more kinds of fluorescent materials are mixed and evaporated.

In the present invention, in the case where a fluorescence converting layer is formed using two or more kinds of fluorescent materials, the fluorescence converting layer may be formed by layering two or more evaporation layers formed by individually evaporating the respective fluorescent material. In the case where a fluorescence converting layer is formed by co-evaporating two or more kinds of fluorescent materials, the operation is complicated because it is indispensable to accurately control the amounts of fluorescent materials to be added. To the contrary, in the case where the fluorescence converting layer is formed by layering two or more evaporation layers formed by individually evaporating the respective fluorescent material, a fluorescence converting layer having a desired wavelength converting characteristic can be simply formed even when vapor pressures of the respective fluorescent materials differ greatly.

Further, in the present invention, in the case where a fluorescence converting layer is formed by layering two or more evaporation layers formed by individually evaporating the respective fluorescent material, each evaporation layer may be formed by co-evaporating two or more kinds of fluorescent materials.

In the present invention, conditions for evaporating fluorescent materials are not specifically limited but evaporation is preferably conducted under a pressure not greater than 1×10⁻⁴ Pa and at a rate of about 0.01 to 1 nm/second.

In the present invention, the passivation layer can be formed of a silicon compound such as silicon oxide (SiOx), silicon nitride (SiNy) or the like but it is preferable to form it of a silicon oxide as a simple substance or a complex layer of silicon oxide and silicon nitride so as to include silicon oxide.

In the present invention, a passivation layer is preferably formed of a silicon compound such as silicon oxide, silicon nitride or the like but it can be formed of an organic transparent resin, an inorganic transparent resin or the like if materials used therefor do not affect a color filter layer or a color filter or a fluorescence converting layer.

In the present invention, in the case where there is some possibility of a passivation layer formed by silicon oxide, silicon nitride or a complex layer of silicon oxide and silicon nitride containing defects such as pin holes or foreign materials, a protection layer may be formed of an organic transparent resin, an inorganic transparent resin or the like on the passivation layer formed of silicon oxide, silicon nitride or a complex layer of silicon oxide and silicon nitride, in order to protect it.

A passivation layer preferably has a refractive index of 1.40 to 1.55 at a wavelength of 632 nm and it is more preferable for a passivation layer to have a refractive index of 1.44 to 1.48 at a wavelength of 632 nm. When the passivation layer has a higher refractive index at a wavelength of 632 nm, the performance of the passivation layer for protecting a color filter layer or a color filter or a fluorescence converting layer from components contained in an organic light emitting layer is degraded and, on the other hand, when the passivation layer has a lower refractive index at a wavelength of 632 nm, the performance of the passivation layer for protecting a color filter layer or a color filter or a fluorescence converting layer from water components or the like is degraded.

In the case where a passivation layer is formed of silicon oxide (SiOx), x is preferably in the range of from 1.8 to 2.2 and more preferably from 1.90 to 2.05. It is sufficient for the average value of x to lie within this range and the value of x may be varied at a constant rate in the thickness direction of the passivation layer.

In the case where a passivation layer is formed of silicon nitride (SiNy), y is preferably in the range of from 0.1 to 0.5. It is sufficient for the average value of y to lie within this range and the value of y may be varied at a constant rate in the thickness direction of the passivation layer.

A passivation layer may contain 0.5 weight % or less of C, Ar and the like as impurities and may further contain 30 atom % or less of H in order to relieve stress in the passivation layer.

Apassivation layer may have an average surface roughness (Ra) of 2 to 50 nm and preferably has a maximum surface roughness (Rmax) of 10 to 50 nm.

A passivation layer may preferably have a transmissivity capable of transmitting 80% or more of light emitted from an organic light emitting layer.

The thickness of a passivation layer is not specifically limited but the passivation layer preferably has a thickness of 5 to 50 nm and more preferably 10 to 30 nm.

In the case where a passivation layer is formed of silicon oxide, it can be formed using a sputtering process or a plasma CVD process but it is preferable to form a passivation layer by a sputtering process, in particular, a high frequency sputtering process using an RF power source. The power of the high frequency sputtering process using an RF power source is preferably controlled within a range from 10 to 100 W/cm², and it is preferable to control the frequency thereof to 13.56 MHz, the forming rate of the passivation layer within a range from 5 to 50 nm/min and the pressure during forming the passivation layer within a range from 0.1 to 1.0 Pa.

In the case where a passivation layer containing silicon oxide is formed by a sputtering process, an inert gas used in a conventional sputtering apparatus may be employed as the sputtering gas but it is preferable to employ one or a mixture of two or more inert gases selected from the group consisting of Ar, Kr and Xe. When one of Ar, Kr and Xe is used as a primary sputtering gas, the distance between the substrate and the target is determined within a range from 20 to 60 Pa-cm, particularly, from 30 to 50 Pa-cm. Ar is most preferably employed among Ar, Kr and Xe.

In the present invention, an organic EL device includes a color filter formed by evaporating pigments and/or organic dyes. The color filter preferably includes a first color filter, a second color filter and a third color filter formed adjacent to each other, the first color filter having a light transmission characteristic for transmitting light of 573 to 780 nm, the second color filter having a light transmission characteristic for transmitting light of 493 to 573 nm and the third color filter having a light transmission characteristic for transmitting light of 380 to 493 nm.

More specifically, in the present invention, the first color filter has a light transmission characteristic for transmitting light of 578 to 620 nm, the second color filter has a light transmission characteristic for transmitting light of 520 to 570 nm and the third color filter has a light transmission characteristic for transmitting light of 430 to 470 nm.

By constituting the color filter in this manner, an organic EL device can transmit the three primary colors of light, namely, red, green and blue lights, irrespective of the wavelength of light emitted from an organic light emitting layer. Therefore, arbitrary colors can be displayed not only when an organic light emitting layer for emitting white light but also when organic materials having a low color purity but a long lifetime and capable of emitting lights whose colors are close to red, green and blue with high efficiency are employed as constituents of an organic light emitting layer.

In the present invention, a color filter may have a light transmission characteristic for transmitting light of 573 to 780, a light transmission characteristic for transmitting light of 493 to 573 nm or a light transmission characteristic for transmitting light of 380 to 493 nm. More preferably, the color filter has a light transmission characteristic for transmitting light of 573 to 620 nm, a light transmission characteristic for transmitting light of 520 to 570 nm or a light transmission characteristic for transmitting light of 430 to 470 nm.

By constituting the color filter of an organic EL device so as to have such a characteristic, the organic EL device can produce one of the three primary colors of light, namely, red, green and blue lights, irrespective of the wavelength of light emitted from an organic light emitting layer and, therefore, when the organic EL device is used for a color display, a specific color can be displayed a t a specific portion of the color display.

An organic EL display panel or an organic EL device according to the present invention includes at least one organic light emitting layer between two electrodes one of which is transparent and the at least one organic light emitting layer contains one or two kinds of compounds relating to a light emitting function.

In an organic EL device according to the present invention, the wavelength of light emitted from the at least one organic light emitting layer is not specifically limited but the at least one organic light emitting layer is constituted so as to preferably emit white light having a continuous spectrum in at least a wavelength range of 380 to 780 nm.

In the present invention, it is preferable for the at least one organic light emitting layer to be constituted so as to emit white light having a continuous spectrum in the wavelength range of 430 nm to 650 nm or shorter.

In the present invention, an organic light emitting layer includes a host material which is a compound capable of transporting holes, a compound capable of transporting electrons or the mixture thereof and has a function of injecting holes and electrons, transporting them and recombining holes and electrons to create excitons. For the organic light emitting layer, it is preferable to employ a relatively electronically neutral compound.

Compounds preferably used as a host material for an organic light emitting layer include triazole derivatives, oxadiazole derivatives, imidazole derivatives, polyarylalkane derivatives, pyrazoline derivatives, pyrazolone derivatives, phenylenediamine derivatives, arylamine derivatives, amino-substitued chalcone derivatives, oxazole derivatives, styrylanthracene derivatives, fluorenone derivatives, hydrazone derivatives and stilbene derivatives, and triphenyldiamine derivatives are preferably employed as a host material for an organic light emitting layer.

As an example of triphenyldiamine derivatives, tetraarylbenzidine compounds (triaryldiamine or triphenyldiamine: TPD) are particularly preferable.

Preferable specific examples of tetraarylbenzidine compounds (TDP) are as follows.

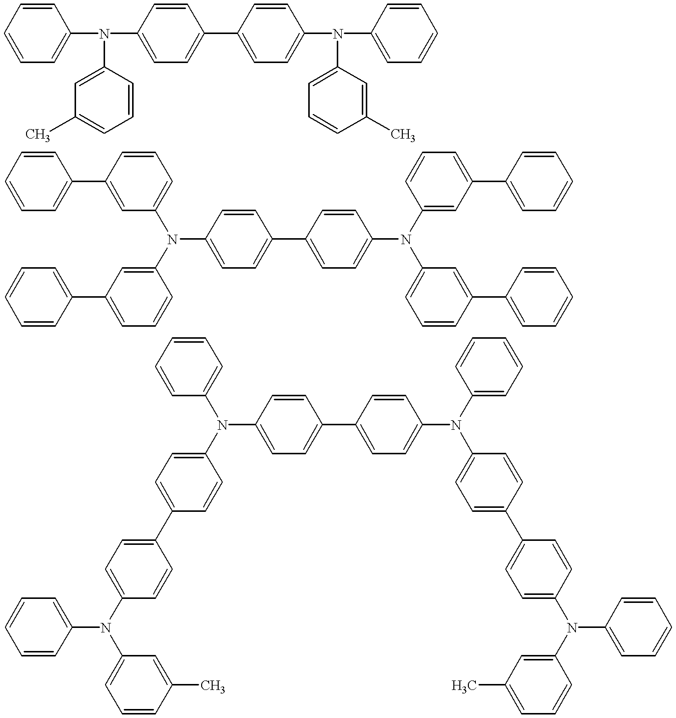

For compounds capable of injecting and transporting electrons used as a host material for an organic light emitting layer, quinoline derivatives are preferably used and it is more preferable to use metal complexes containing 8-quinolinol or derivatives thereof as ligands, particularly, tris(8-quinolinolato) aluminum (Alq3) having a chemical structure as shown by the following formula. It is also possible to employ phenylanthracene derivatives, tetraarylethene derivatives or the like.

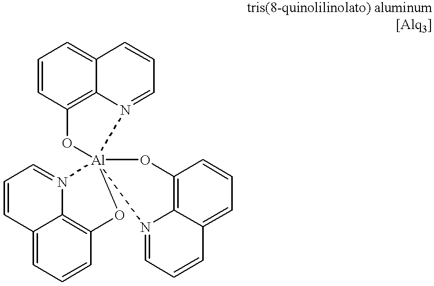

In the present invention, an organic light emitting layer preferably has a comosition obtained by doping a compound capable of transporting holes, a compound capable of transporting electrons or a mixture thereof constituting a host material with a fluorescent substance as a dopant.

Further, an organic EL display panel and an organic EL device according to the present invention is preferably provided with two organic light emitting layers laminated to each other. In the case where two organic light emitting layers are provided, wider light emission band width can be obtained and the degree of freedom in the color of emitted light can be improved by doping them with fluorescent substances for emitting light of different wavelengths.

In the present invention, it is preferable to employ, as fluorescent substances to be added as a dopant, compounds disclosed in Japanese Patent Application Laid Open No. 63-264692, specifically, one or more compounds selected from the group consisting of rubrene type compounds, coumarin type compounds, quinacridone type compounds and dicyanomethylpyran type compounds.

Illustrative examples of fluorescent substances preferably used in the present invention are as follows.

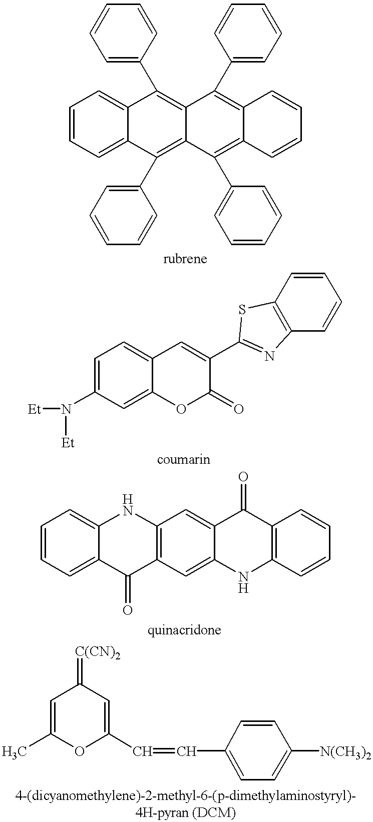

Further, in the present invention, naphthacene type compounds disclosed in Japanese Patent Application Laid Open No. 2000-26334 and Japanese Patent Application Laid Open No. 2000-26337 can be also preferably used as a fluorescent substance to be added as a dopant and the lifetime of an organic EL device can be markedly improved by using it in combination with rubrene type compounds, coumarin type compounds, quinacridone type compounds, dicyanomethylpyran type compounds or the like.

Naphthacene type compounds preferably used as a fluorescent substance to be added as a dopant in the present invention have a basic skeleton as shown by formula (I).

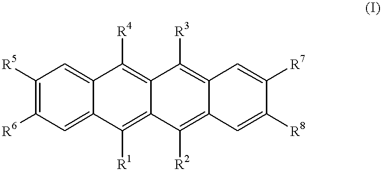

In formula (I), R¹ to R⁴ designate one of a substituted or unsubstituted alkyl group, aryl group, amino group, heterocyclic group and alkenyl group and they are preferably one of an aryl group, an amino group, a heterocyclic group and an alkenyl group.

The aryl groups represented by R¹ to R⁴ may be monocyclic or polycyclic, inclusive of fused rings and a collection of rings. Those aryl groups having 6 to 30 carbon atoms in total are preferred and they may have substituents.

The aryl groups represented by R¹ to R⁴ are preferably those having a phenyl group, an o-, m- or p-tolyl group, a pyrenyl group, a perylenyl group, coronenyl group, a 1-, or 2-naphthyl group, an anthryl group, an o-, m-, or p-biphenylyl group, a terphenyl group, a phenanthryl group or the like.

The amino groups represented by R¹ to R⁴ may be selected from among an alkylamino group, an arylamino group, an aralkylamino group and the like. They preferably have aliphatic groups having 1 to 6 carbon atoms in total and/or aromatic carbocyclic groups having 1 to 4 rings. Illustrative examples include a dimethylamino group, a diethylamino group, a dibutylamino group, a diphenylamino group, a ditolylamino group, a bisdiphenylamino group, a bisnaphthylamino group and the like.

The heterocyclic groups represented by R¹ to R⁴ include 5- or 6-membered ring aromatic heterocyclic groups containing O, N or S as a hetero atom, and fused polycyclic aromatic heterocyclic groups having 2 to 20 carbon atoms.

The alkenyl groups represented by R¹ to R⁴ are preferably those having a phenyl group as at least one substituent, such as a 1- and 2-phenylalkenyl group, a 1,2- and 2,2-diphenylalkenyl group, and a 1,2, 2-triphenylalkenyl group and the like, although unsubstituted alkenyl groups are acceptable.

Illustrative examples of the aromatic heterocyclic groups and the fused polycyclic aromatic groups include a thienyl group, a furyl group, a pyrolyl group, a pyridyl group, a quinolyl group, a quinoxalyl group and the like.

When R¹ to R⁴ have substituents, it is preferred that at least two of the substituents be selected from among the aryl group, the amino group, the heterocyclic group, the alkenyl group and the aryloxy group. The aryl group, the amino group, the heterocyclic group and the alkenyl group are as defined above for R¹ to R⁴.

The aryloxy groups to substitute on R¹ to R⁴ are preferably those of aryl groups having 6 to 18 carbon atoms in total, for example, o-, m- and p-phenoxy.

At least two of the these substituents may form a fused ring. Also, these substituents may be further substituted ones, in which preferred substituents are as described above.

When R¹ to R⁴ have su-bstituents, it is preferred that at least two of the substituents have the above-described substituents. The position of the substitution is not particularly limited and may be a meta, para, ortho position. R¹ and R⁴, and R² to R³ in the respective pairs are preferably identical although they may be different.

In the formula (I), at least five kinds, preferably six kinds or more, among R¹ to R⁸ are substituted or unsubstituted alkyl groups, aryl groups, amino groups, alkenyl groups and heterocyclic groups.

The alkyl groups represented by R⁵, R⁶, R⁷ and R⁸ are preferably those having 1 to 6 carbon atoms and they may have a straight chain or be bifurcated. Illustrative examples of the alkyl groups represented by R⁵, R⁶, R⁷ and R⁸ preferably include a methyl group, an ethyl group, n- and i-propyl groups, n-, i-, sec- and tert-butyl groups, n-, i-, neo- and tert-pentyl groups and the like.

The aryl groups, the amino groups and the alkenyl groups are preferably those as defined above for R¹ to R⁴. R⁵ and R⁶, and R⁷ to R⁸ in the respective pairs are preferably identical, although they may be different.

In the present invention, compounds as a fluorescent substance to be added as a dopant preferably include the following compounds.

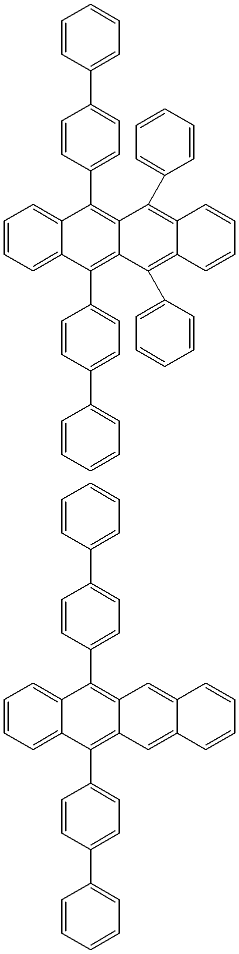

In the case where two organic light emitting layers are formed, it is preferable that each organic light emitting layer contains two or more kinds of these fluorescent substances and that the two or more kinds of fluorescent substances emit light having different wavelengths.

In the present invention, an amount of the dopant contained in the organic light emitting layer is preferably from 0.01 to 20% on a weight basis and more preferably from 0.1 to 15% on a weight basis.

In the present invention, the thickness of the organic light emitting layer is not particularly limited but is normally from 5 to 500 nm and more preferably from 10 to 300 nm although the preferable thickness thereof depends upon methods for forming the same.

In the present invention, in the case where two organic light emitting layers are formed, each of the organic light emitting layer has a thickness that is equal to or greater than the thickness of a single molecular layer and less than the thickness of the entire organic light emitting layers. More specifically, each of the organic light emitting layer has a thickness of 1 to 85 nm, preferably 5 to 60 nm, more preferably 5 to 50 nm.

In the present invention, the organic light emitting layer is preferably formed by means of evaporation.

In the present invention, conditions for forming the organic light emitting layer by evaporation are not particularly limited. Specifically, the organic light emitting layer is formed by evaporation under a pressure equal to or less than 1×10⁻⁴ and at a rate of about 0.01 to 1 nm/second.

In the present invention, the organic light emitting layer preferably contains a mixture of a compound capable of transporting holes and a compound capable of injecting and transporting electrons.

In the case where the organic light emitting layer contains a mixture of a compound capable of transporting holes and a compound capable of injecting and transporting electrons, since hopping transmittance paths of carriers are formed, each carrier moves in a substance whose polarity is dominant and it becomes hard for carriers having opposite polarity to be injected. Therefore, since compounds contained in the organic light emitting layer are protected from damage, the lifetime of the organic EL device can be advantageously improved.

Further, when dopant including fluorescent substance is contained in a compound capable of transporting holes and a compound capable of injecting and transporting electrons, since the emitted light wavelength characteristic of the organic light emitting layer itself can be changed, the wavelength of light emitted from the organic light emitting layer can be shifted to the longer wavelength side and not only the intensity of light emitted therefrom but also the stability of the organic EL device can be improved.

In the case where the organic light emitting layer contains a mixture of a compound capable of transporting holes and a compound capable of injecting and transporting electrons, the ratio of mixing the compound capable of transporting holes with respect to the compound capable of injecting and transporting electrons is determined depending upon the carrier mobility and carrier density. In general, however, the weight ratio between the compound capable of transporting holes and the compound capable of injecting and transporting electrons is selected to be of the order of 1/99 to 99/1, preferably 10/90 to 90/10, more preferably 20/80 to 80/20, and most preferably 40/60 to 60/40.

In the case where the organic light emitting layer containing a mixture of a compound capable of transporting holes and a compound capable of injecting and transporting electrons is formed, it is preferable to accommodate the mixture of a compound capable of transporting holes and the compound capable of injecting and transporting electrons in different evaporation sources, and to vaporize and co-evaporate them. However, when the vapor pressures of the compound capable of transporting holes and the compound capable of injecting and transporting electrons are substantially the same or very close to each other, it is possible to mix them in advance in an evaporation source and evaporate them.

In the case where the organic light emitting layer containing a mixture of a compound capable of transporting holes and a compound capable of injecting and transporting electrons is formed, it is preferable that the compound capable of transporting holes and the compound capable of injecting and transporting electrons be uniformly mixed in the organic light emitting layer, although it is not absolutely necessary for them to be uniformly mixed in the organic light emitting layer.

In the present invention, the organic EL display panel or the organic EL device preferably includes, in addition to at least one organic light emitting layer, a hole injecting and transporting layer having a function of facilitating injection of holes from a hole injecting electrode, a function of stably transporting holes and a function of preventing electrons from being transported, and an electron injecting and transporting layer having a function of facilitating injection of electrons from an electron injecting electrode, a function of stably transporting electrons and a function of preventing holes from being transported. By providing these layers, the number of holes and electrons injected into the organic light emitting layer can be increased and they can be confined in the organic light emitting layer so that re-combining regions can be optimized, thereby improving the light emitting efficiency.

In the present invention, more preferably, the organic EL device includes a hole injecting electrode, a hole injecting layer having a function of facilitating injection of holes from the hole injecting electrode, a hole transporting layer having a function of stably transporting holes and preventing electrons from being transported, two organic light emitting layers, an electron transporting layer having a function of stably transporting electrons and a function of preventing holes from being transported, an electron injecting layer having a function of facilitating injection of electrons from an electron injecting electrode, and the electron injecting electrode.

In the present invention, illustrative examples of compounds preferably used for the hole injecting and transporting layer, the hole injecting layer and the hole transporting layer include tetraarylbenzidine compounds (triaryldiamine or triphenyldiamine: TPD), aromatic tertiary amine, hydrazone derivatives, carbazole derivatives, triazole derivatives, imidazole derivatives, oxadiazole derivatives having an amino group, polythiophene and the like. Among them, tetraarylbenzidine compounds (triaryldiamine or triphenyldiamine: TPD) and triarylamine polymers disclosed in WO/98/30071 are particularly preferable.

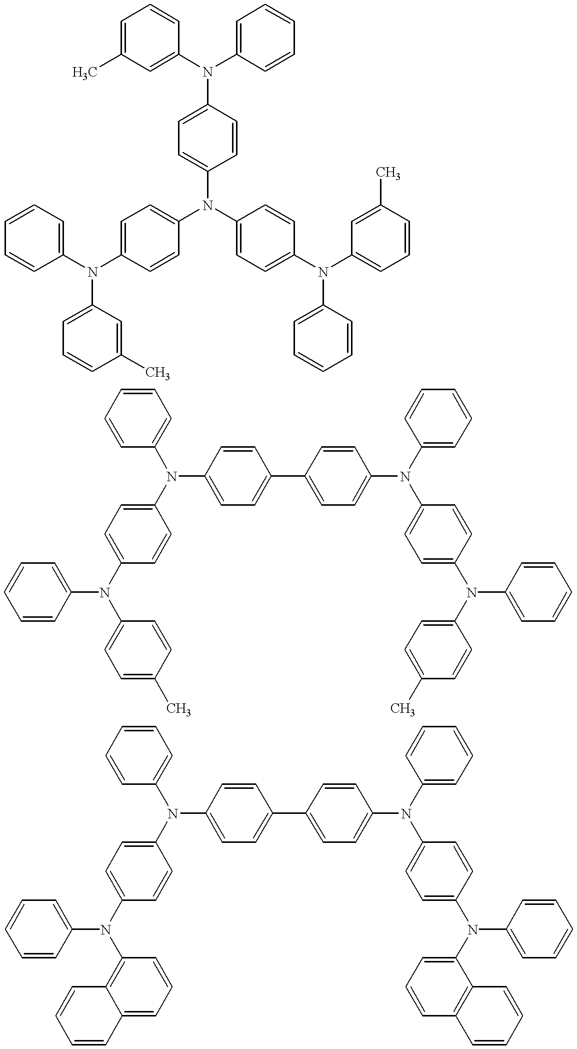

In the present invention, organic compounds disclosed in Japanese Patent Application Laid Open No. 63-295695, Japanese Patent Application Laid Open No. 2-191694, Japanese Patent Application Laid Open No. 3-792, Japanese Patent Application Laid Open No. 5-234681, Japanese Patent Application Laid Open No. 5-239455, Japanese Patent Application Laid Open No. 5-299174, Japanese Patent Application Laid Open No. 7-126225, Japanese Patent Application Laid Open No. 7-126226, Japanese Patent Application Laid Open No. 8-100172, European Patent Publication EP 0650955 A1 and the like can be used for the hole injecting and transporting layer, the hole injecting layer and the hole transporting layer.

In the present invention, two or more kinds of these compounds may be used together and in the case where two or more kinds of these compounds are used together, they may be mixed into a single layer or two or more layers formed using them may be layered.

In the case where a hole injecting layer and a hole transporting layer are formed by dividing the hole injecting and transporting layer, preferred combination of compounds can be selected from among the above-described compounds. At this time, it is possible to laminate layers of compounds from the hole injecting electrode, such as an ITO electrode, in order from compounds having smaller ionization potential to those having greater ionization potential. Further, it is preferable to form a layer of compounds having good thin layer forming ability on the hole injecting electrode. In particular, it is preferable to use said ATP for the hole injecting electrode and use said TPD for the hole transporting layer. By this, it is possible to decrease driving voltage and prevent leak current and dark spots from occurring and growing.

In the present invention, the hole injecting and transporting layer, the hole injecting layer and the hole transporting layer may be formed by evaporating the above-described compounds. In the case where the hole injecting and transporting layer, the hole injecting layer and the hole transporting layer are formed by evaporation, since a thin layer having no pinholes and a thickness of about 1 to about 10 nm can be formed, ionization potential of the hole injecting layer is low and, therefore, even when a compound for absorbing light having a visible wavelength is employed, it is possible to prevent the degradation of light emitting efficiency caused by change in hue and re-absorption of emitted light can be prevented.

In the present invention, an electron injecting and transporting layer can be divided into an electron injection layer and an electron transporting layer. Illustrative examples preferably used for the electron injecting and transporting layer, the electron injection layer and the electron transporting layer include metal complexes containing 8-quinolinol such as tris(8-quinolinolato) aluminum (Alq3) or derivatives thereof as ligands, oxadiazole derivatives, perylene derivatives, pyridine derivatives, pyrimidine derivatives, quinoxalyne derivativesb and the like.

In the present invention, the electron injecting and transporting layer, the electron injection layer and the electron transporting layer may be formed by evaporating the above-described compounds.

In the present invention, the conditions for forming the organic light emitting layer, the hole injecting and transporting layer or the hole injecting layer and the hole transporting layer by evaporation are not critical, although a vacuum of 1×10⁻⁴ Pa or less and an evaporation rate of about 0.01 to 1 nm/second are preferable. It is preferable to continuously form each of the layers under the vacuum of 1×10⁻⁴ Pa or less. Since it is possible to prevent impurities from being adsorbed on the interface between adjacent layers by continuously forming each of the layers under a vacuum of 1×10⁻⁴ Pa or less, an organic EL device having high characteristics can be obtained and it is further possible to lower the drive voltage of an organic EL device, thereby preventing dark spots from being generated and growing.

In the present invention, in the case where two or more kinds of compounds are added to the organic light emitting layer, the hole injecting and transporting layer, the hole injecting layer, the hole transporting layer, the electron injecting and transporting layer, the electron injecting layer or the electron transporting layer, it is preferable to individually control the temperature of each board containing compounds and form the organic light emitting layer, the hole injecting and transporting layer, the hole injecting layer, the hole transporting layer, the electron injecting and transporting layer, the electron injecting layer or the electron transporting layer by co-evaporating them.

In the present invention, instead of the hole injecting and transporting layer or the hole injecting layer and the hole transporting layer, or in addition thereto, it is possible to provide a high resistance inorganic hole injecting and transporting layer having conduction paths for holes and a function of blocking electrons.

By providing a high resistance inorganic hole injecting and transporting layer having conduction paths for holes and a function of blocking electrons in this manner, it is possible to efficiently inject holes into the organic light emitting layer, thereby improving the light emitting efficiency and to decrease the driving voltage. Further, by providing a high resistance inorganic hole injecting and transporting layer having conduction paths for holes and a function of blocking electrons, the thickness of the organic EL display panel or the organic EL device can be reduced and it is possible to make the thickness of the organic EL display panel or the organic EL device made thin by forming the color filter layer or the color filter by evaporation even thinner.

In the present invention, it is preferable to use an oxide of a metal or metalloid such as silicon or germanium as the main component of the inorganic hole injecting and transporting layer and include therein at least one member selected from among oxides, carbides, nitrides, silicides and borides of metals and metalloids having a work function of at least 4.5 eV, preferably 4.5 to 6 eV to form conduction paths. This enables not only effective injection of holes from the hole injecting electrode to the organic light emitting layer but also the migration of electrons from the organic light emitting layer to the hole injecting electrode to be restricted, thereby effectively recombining holes and electrons in the organic light emitting layer.

In the case where a high resistance inorganic hole injecting and transporting layer is provided, it is possible to produce a luminance equal to or greater than that of the prior art organic EL device having an organic hole injecting and transporting layer or an organic hole injecting layer and an organic hole transporting layer. Moreover, owing to the high heat resistance and weather resistance of the inorganic hole injecting and transporting layer, the organic EL device has a longer lifetime than the prior art device and the contact with the hole injecting electrode formed by an inorganic material can be improved, thereby minimizing current leaks and dark spots. Further, since an organic material for forming the inorganic hole injecting and transporting layer is inexpensive and readily available, unlike a relatively expensive organic material, and the inorganic hole injecting and transporting layer can be easily formed, the cost of manufacturing an organic EL device or an organic EL display panel can be reduced.

Preferably, the high resistance inorganic hole injecting and transporting layer has a resistivity of 1 Ω-cm to 1×10¹¹ Ω-cm and more preferably 1×10³ Ω-cm to 1×10⁸ Ω-cm. By controlling the resistivity of the inorganic hole injecting and transporting layer within this range, the efficiency of hole injection can be drastically increased while maintaining high electron blockage. The resistivity of the inorganic hole injecting and transporting layer may be determined from sheet resistance and film thickness.

The high resistance inorganic hole injecting and transporting layer preferably contains, as a main component, an oxide of silicon and germanium represented by the formula: (Si₁₋ₓGeₓ)Oy, wherein x is 0 to 1 and y is 1.7 to 2.2, preferably 1.7 to 1.99. The main component of the inorganic hole injecting and transporting layer may be silicon oxide (namely, x is equal to or less than 0.5) or germanium oxide (namely, x exceeds 0.5) or the inorganic hole injecting and transporting layer may be a thin film of silicon oxide and germanium oxide. It is not preferable for y to be outside of this range because the hole injection performance of the layer is degraded. The composition of the inorganic hole injecting and transporting layer may be examined by Rutherford backscattering spectrometry, chemical analysis or the like.

Preferably, the inorganic hole injecting and transporting layer further contains at least one member selected from among metals, metalloids and oxides, carbides, nitrides, silicides and borides of the metals and metalloids having a work function of at least 4.5 eV, preferably 4.5 to 6 eV Illustrative examples of the metal and metalloid having a work function of at least 4.5 eV, preferably 4.5 to 6 eV include Au, Cu, Fe, Ni, Ru, Sn, Cr, Ir, Nb, Pt, Mo, W, Ta, Pd and Co. These metals, metalloids and oxides, carbides, nitrides, silicides and borides thereof may be admixtures and the mixtures may have an arbitrary mix ratio. The content thereof is preferably 0.2 to 40 mol %, more preferably 1 to 20 mol %. If the content is less than 0.2 mol %, the hole injecting performance of the layer declines, while if the content exceeds 40 mol %, the electron blocking performance of the layer declines. When two or more kinds thereof are used, the total content thereof should preferably fall within the above range.

The metals, metalloids and oxides, carbides, nitrides, silicides and borides thereof are generally dispersed in the high resistance inorganic hole injecting and transporting layer. The dispersed particles generally have a particle size of about 1 to 5 nm. It is thought that hopping paths are formed for transporting holes between these conductive dispersed particles via high resistance oxides of silicon and germanium contained as a main component.

The high resistance inorganic hole injecting and transporting layer may additionally contain as impurities hydrogen, and neon, argon, krypton, xenon and other elements which are used as the sputtering gas, in a total amount of up to 5 atom %.

As long as the high resistance inorganic hole injecting and transporting layer has the above-described composition on average, the layer need not be uniform in composition and may be of a structure having a concentration gradient in the thickness direction.

The high resistance inorganic hole injecting and transporting layer is normally amorphous.

The thickness of the high resistance inorganic hole injecting and transporting layer is preferably about 0.3 to 100 nm, more preferably 1 to 100 nm and most preferably 5 to 30 nm. When the thickness of the high resistance inorganic hole injecting and transporting layer is less than 0.3 nm or when it exceeds 100 nm, the high resistance inorganic hole injecting and transporting layer fails to fully exert the hole injecting performance.

The high resistance inorganic hole injecting and transporting layer is preferably formed by a sputtering process, although usable processes for forming the high resistance inorganic hole injecting and transporting layer include various physical and chemical thin film forming processes such as sputtering, evaporation or the like. Inter alia, it is preferable to form the high resistance inorganic hole injecting and transporting layer by a multi-source sputtering process of separately sputtering a target of oxide of silicon and germanium as the main component and a target of one or more members selected from among the metal, metalloid and oxide, carbide, nitride, silicide and boride of the metal and metalloid having a work function of at least 4.5 eV. The multi-source sputtering process permits appropriate sputtering conditions to be employed for the respective targets. If the composition is controlled by resting small pieces of one or more members selected from among the metal, metalloid and oxide, carbide, nitride, silicide and boride thereof on a target of the main component and properly adjusting the ratio of their areas, a single-source sputtering process may be used for forming the inorganic hole injecting and transporting layer.

In the case where the high resistance inorganic hole injecting and transporting layer is formed by the sputtering process, the sputtering gas is preferably under a pressure of 0.1 to 1 Pa during sputtering. The sputtering gas may be any inert gas used in conventional sputtering, for example, Ar, Ne, Xe, Kr or the like. Nitrogen gas may be used as occasion demand. About 1 to about 99% of oxygen gas may be mixed with these sputtering gases during sputtering.

The sputtering process may be a high frequency sputtering process using an RF power source or a DC sputtering process. The sputtering power is preferably in the range of 0.1 to 10 W/cm² for the high frequency sputtering using an RF power source. The deposition rate is in the range of 0.5 to 10 nm/min., preferably 1 to 5 nm/min.

The temperature of the substrate during sputtering is from about 25 to about 150° C.

In the present invention, instead of the electron injecting and transporting layer or the electron injecting layer and the electron transporting layer, or in addition thereto, it is possible to provide a high resistance inorganic electron injecting and transporting layer having conduction paths for electrons and a function of blocking holes.

By providing a high resistance inorganic electron injecting and transporting layer having conduction paths for electrons and a function of blocking holes in this manner, it is possible to efficiently inject electrons into the organic light emitting layer, thereby improving the light emitting efficiency and decreasing the driving voltage. Further, by providing a high resistance inorganic electron injecting and transporting layer having conduction paths for electrons and a function of blocking holes, the thickness of the organic EL display panel or the organic EL device can be reduced and it is possible to make the thickness of the organic EL display panel or the organic EL device made thin by forming the color filter layer or the color filter by evaporation even thinner.

The high resistance inorganic electron injecting and transporting layer preferably comprises as a first component an oxide which has a work function of 4 eV or lower and preferably 1 to 4 eV, and is selected from the group consisting of an oxide or oxides of at least one alkali metal element selected from the group consisting of Li, Na, K, Rb, Cs and Fr, an oxide or oxides of at least one alkaline earth metal element selected from the group consisting of Mg, Ca and Sr, and an oxide or oxides of at least one lanthanide element selected from the group consisting of La and Ce. Of these oxides, lithium oxide, magnesium oxide, calcium oxide and cerium oxide are most preferred. When these elements are mixed for use, the ratio of the mixture may be arbitrarily determined. When these elements are mixed for use, the mixture preferably contains lithium oxide in an amount of at least 50 mol % as calculated in the form of LiO₂.

The high resistance inorganic electron injecting and transporting layer further contains as a second component at least one element selected from the group consisting of Zn, Sn, V, Ru, Sm and In. The content of the second component should preferably be 0.2 to 40 mol %, more preferably 1 to 20 mol %. If the content of the second component is less than 0.2 mol %, the electron injecting performance of the layer declines and, on the other hand, if the content of the second component exceeds 40 mol %, the hole blocking performance of the layer declines. When two or more kinds of elements are used in combination, it is preferred that the total content of the elements be within the above range. The second element may be present in the form of either a metal element or an oxide.

By adding 0.2 to 40 mol % of one or more elements selected from the group consisting of Zn, Sn, V, Ru, Sm and In as a second component to the high resistance first component, thereby forming conduction paths, it is possible to efficiently inject electrons from the electron injecting electrode into the organic light emitting layer. It is thought that this is because adding the second component into the first component makes conductive materials present island-like in the insulating material to form hopping paths for injecting electrons.

By adding 0.2 to 40 mol % of the second component into the first component, it is possible to restrain holes from moving from the organic light emitting layer to the electron injecting electrode, thereby efficiently recombining holes and electrons in the organic light emitting layer.

In the case where the high resistance inorganic electron injecting and transporting layer is provided, it is possible to produce a luminance equal to or greater than that of the prior art organic EL device having an organic electron injecting and transporting layer or an organic electron injecting layer and an organic electron transporting layer. Moreover, owing to the high heat resistance and weather resistance of the inorganic electron injecting and transporting layer, the organic EL device has a longer lifetime than the prior art device and the connectability with the electron injecting electrode formed by an inorganic material can be improved, thereby minimizing current leaks and dark spots. Further, since an organic material for forming the inorganic electron injecting and transporting layer is inexpensive and readily available, unlike a relatively expensive organic material, and the inorganic electron injecting and transporting layer can be easily formed, the cost of manufacturing an organic EL device or an organic EL display panel is reduced.

Preferably, the high resistance inorganic electron injecting and transporting layer has a resistivity of 1 Ω-cm to 1×10¹¹ Ω-cm and more preferably 1×10³ Ω-cm to 1×10⁸ Ω-cm. By controlling the resistivity of the inorganic electron injecting and transporting layer within this range, the efficiency of electron injection can be drastically increased while maintaining high hole blockage. The sheet resistance can be measured using the four terminal method or the like.

Although the first component oxide usually has a stoichiometric composition, it may deviate slightly from the stoichiometric composition or it may have a non-stoichiometric composition. The same also holds for the second component oxide.

The high resistance inorganic electron injecting and transporting layer may further contain as impurities H, and Ne, Ar, Kr, Xe or the like used as sputtering gases in a total amount of 5 atom % or less.

The high resistance inorganic electron injecting and transporting layer is normally amorphous.

The thickness of the high resistance inorganic electron injecting and transporting layer is preferably 0.2 to 30 nm and particularly preferably 0.2 to 20 nm. If the thickness of the high resistance inorganic electron injecting and transporting layer is less than 0.2 nm or exceeds 30 nm, the layer does exhibit a sufficient electron injecting function.

The high resistance inorganic electron injecting and transporting layer is preferably formed by a sputtering process, although processes for forming the high resistance inorganic electron injecting and transporting layer include various physical and chemical thin film forming processes such as sputtering, evaporation and the like. Inter alia, it is preferable to form the high resistance inorganic electron injecting and transporting layer by a multi-source sputtering process wherein targets for the first component and the second component are separately sputtered. According to the multi-source sputtering process, suitable sputtering conditions can be applied to the respective targets. Further, the high resistance inorganic electron injecting and transporting layer may be formed by a single sputtering process using a mixed target wherein the first component and the second component are mixed together.

In the case where the high resistance inorganic electron injecting and transporting layer is formed by a sputtering process, the sputtering gas is preferably under a pressure of 0.1 to 1 Pa during sputtering. The sputtering gas may be any inert gas used in conventional sputtering, for example, Ar, Ne, Xe, Kr or the like. Nitrogen gas may be used as occasion demand. About 1 to about 99% of oxygen gas may be mixed to these sputtering gases during sputtering.

The sputtering process may be a high frequency sputtering process using an RF power source or a DC sputtering process. The sputtering power is preferably in the range of 0.1 to 10 W/cm² for the high frequency sputtering using an RF power source. The deposition rate is in the range of 0.5 to 10 nm/min., preferably 1 to 5 nm/min.

The temperature of the substrate during sputtering is from about 25 to about 150 ° C.

In the present invention, the hole injecting electrode should preferably be composed of a material that can inject holes in the hole injecting and transporting layer or the hole injecting layer with high efficiency and has a work function of 4.5 to 5.5 eV Illustrative examples of materials preferably used for forming the hole injecting electrode include oxides having as a main component any one of tin-doped indium oxide (ITO), zinc-doped indium oxide (IZO), indium oxide (In₂0₃), tin oxide (SnO₂) and zinc oxide (ZnO). It is noted that these oxides may deviate slightly from their stoichiometric compositions. Regarding tin-doped indium oxide (ITO), the mixing ratio of tin oxide with respect to indium oxide is preferably in the range of 1 to 20 wt% and more preferably 5 to 12 wt%. Regarding zinc-doped indium oxide (IZO), the mixing ratio of zinc oxide with respect to indium oxide is usually in the range of 12 to 32 wt%.

In the present invention, the hole injecting electrode may further contain silicon oxide (SiO₂). The content of silicon oxide (SiO₂) should preferably be of the order of 0.5 to 10% in terms of the molar ratio of silicon oxide (SiO₂) to tin-doped indium oxide (ITO). The incorporation of silicon oxide contributes to an increase in tin-doped indium oxide (ITO).

In the present invention, the electrode on the side out of which light is taken should preferably have a light transmittance of at least 50%, more preferably at least 80% and most preferably at least 90% with respect to light usually emitted at an emission wavelength of 400 to 700 nm. When the light transmittance is less than 50%, it is difficult to obtain the luminance needed for a light emitting device.

In the present invention, the electrode on the side out of which light is taken should preferably have a thickness of 50 to 500 nm and more preferably 50 to 300 nm. It is not preferable for the electrode to be too thick because the light transmittance is lowered and a risk of peeling arises. On the other hand, it is not also preferable for the electrode to be too thin because the strength thereof is lowered.

In the present invention, the electron injecting electrode should preferably be composed of a material that can inject electrons in the electron injecting and transporting layer or the electron injecting layer with high efficiency.

In the case where the electron injecting layer or the electron transporting layer is formed of an organic material, it is preferable as materials for forming the electron injecting electrode to use pure metal elements such as K, Li, Na, Mg, La, Ce, Ca, Sr, Ba, Sn, Zn, Zr and the like or a binary or ternary alloy serving as a stabilizer and containing these elements. Illustrative examples of the binary or ternary alloys include Ag-Mg (Ag: 0.1 to 50 atom%), Al-Li (Li: 0.01 to 14 atom%), In-Mg (Mg: 50 to 80 atom %) and Al-Ca (Ca: 0.01 to 20 atom %).

In the present invention, the electron injecting electrode should preferably have a thickness of at least 0.1 nm, more preferably at least 0.5 nm and most preferably at least 1 nm. Although there is no upper limit to the electron injecting electrode thickness, the electron injecting electrode usually has a thickness of the order of 1 to 500 nm.

To the contrary, in the case where an inorganic electron injecting and transporting layer is formed of an inorganic material, since a low working function and an electron injecting characteristic is unnecessary, materials for forming the electron injecting electrode are not specifically limited and ordinary metals can be employed. Among metals, it is preferable from the viewpoint of conductivity and handling ease to use one or more kinds of metals selected from a group consisting of Al, Ag, In, Ti, Cu, Au, Mo, W, Pt, Pd and Ni, in particular, a group consisting of Al and Ag.

Further, it is preferable to seal the organic EL device by means of a sealing sheet or the like in order to prevent degradation of the organic light emitting layer and the electrodes. For preventing penetration of moisture, the sealing sheet is bonded to the organic EL device using an adhesive resin layer to seal up the device. As a sealing gas, an inert gas such as Ar, He, N₂ or the like is preferably employed. The sealing gas should preferably have a moisture content of not greater than 100 ppm, more preferably not greater than 10 ppm and most preferably not greater than 1 ppm. Although there is no particular lower limit to the moisture content, the lower limit of the moisture content of the sealing gas is usually about 0.1 ppm.

The sealing sheet is preferably in a flat sheet form and may be preferably made of transparent or translucent materials such as glass, quartz, resin or the like, among which the glass is particularly preferable. As glass materials, alkali glass is preferable from a cost standpoint and in particular, a soda glass material subjected to no surface treatment is inexpensive and so is preferable. As resin materials, materials similar to that of the substrate are preferably employed.

The height of the sealing sheet can be controlled as desired by a spacer. The spacer material may be resin beads, silica beads, glass beads, glass fibers or the like and glass beads are particularly preferable among these materials.

It is, however, possible to form a recess in the sealing sheet without using the spacer and when a recess is formed in the sealing sheet, a spacer may be used together. When a spacer is used in addition to forming a recess, it is preferable to use a spacer of 2 to 8 micrometer size.

Any adhesive which can maintain stable bond strength and gas tightness may be used, although ultravaiolet ray curable epoxy resin adhesives of cation curing type are preferred.

In the present invention, in the case where a substrate is located on the side from which light emitted from an organic light emitting layer is taken out, the substrate has to be transparent, while the substrate may be semi-transparent or opaque in the case where it is not located on the side from which light is emitted.

In the present invention, the material of the substrate is not particularly limited but can be selected depending upon the material of electrode layered thereon.

Materials for preferably forming a transparent substrate include glass, and non-alkali glass is particularly preferable among glass materials. Further, since a color filter layer or a color filter is formed by evaporating a pigment and/or an organic dye, transparent resins having relatively low heat resistance such as polycarbonate, polyethylene terephthalate, polybutylene terephthalate, polybutylene naphthalate, polyether sulfone and the like or those on which an inorganic passivation layer is formed can be used as a transparent substrate unless the substrate is contaminated with fat and oil or foreign substances and is damaged.

In the case where the substrate need not be transparent, in addition to glass materials and the above described transparent resins, resins having a relatively high heat resistance such as polyamide imide, polyimide, polyaryl ether nitrile and the like, ceramics such as quartz, alumina and the like, metal sheets such as stainless sheet subjected to isolation processing such as surface oxidation, or the like can be preferably used for the substrate.

The organic EL device and the organic EL display panel according to the present invention are generally of the DC drive type or the pulse drive type, but they may be of the AC drive type.

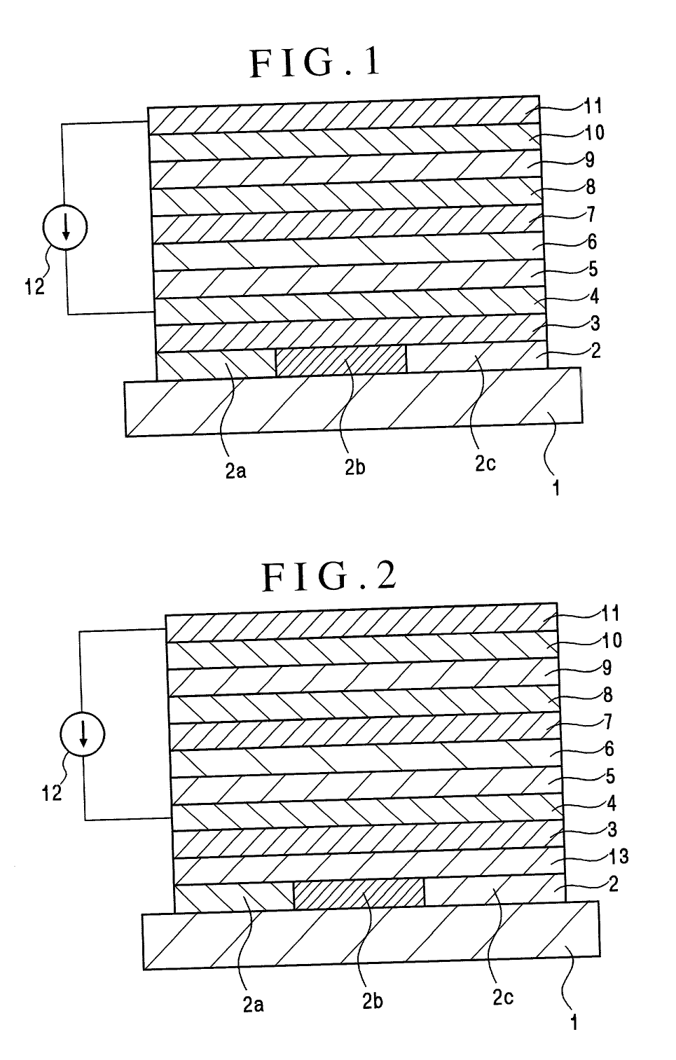

FIG. 1 is a schematic cross-sectional view showing an organic EL device which is a preferred embodiment of the present invention.

As shown in FIG. 1, an organic EL device according to this embodiment is formed by laminating a substrate 1, a color filter 2 formed by evaporating an organic pigment and/or an organic dye using a mask on the substrate 1, a passivation layer 3, a hole injecting electrode 4, a hole injecting layer 5, a hole transporting layer 6, a first organic light emitting layer 7, a second organic light emitting layer 8, an electron transporting layer 9, an electron injecting layer 10 and an electron injecting electrode 11, in this order.

A driving electric source 12 is connected between the hole injecting electrode 4 and the electron injecting electrode 11.

In this embodiment, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out via the substrate 1 and, therefore, the substrate is formed of a transparent material.

According to this embodiment, since the color filter 2 is formed by evaporating an organic pigment and/or an organic dye without using an expensive color resist material containing resins and photosensitive components, it is possible to manufacture an organic EL display panel at much lower cost than the case of an organic EL display panel including a color filter 2 formed by a photo-lithographic process.

Further, according to this embodiment, since the color filter 2 can be formed by only forming evaporation layers for the primary colors using a mask such as a metal mask or the like, it is unnecessary to expose and develop respective resist layers for the primary colors and it is also unnecessary to remove a volatile solvent and the like from the layers after patterning, so that the number of steps is markedly reduced as compared with the case where the color filter 2 is formed by a photo-lithographic process, and therefore, since time required for producing an organic EL display panel can be markedly reduced, the cost of manufacturing an organic EL display panel can be greatly reduced.

Furthermore, according to this embodiment, since the color filter 2 is formed by evaporating an organic pigment and/or an organic dye, the thickness of the color filter 2 can be markedly reduced, thereby enabling the thickness of an organic EL display panel to be greatly reduced.

Moreover, according to this embodiment, since the color filter 2 is formed by evaporating an organic pigment and/or an organic dye, the thickness of the color filter 2 can be markedly reduced. Therefore, since no overcoat layer is needed, the transparent electrode and auxiliary hard wiring formed on the color filter layers can be reliably prevented from being cut due to fluctuation in thickness of the color filter 2 and the overcoat layer.

Further, according to this embodiment, when the color filter 2 is formed by evaporating an organic pigment and/or an organic dye, the angle of walls formed at the border portion between the color filter 2 and a portion where no color filter is formed can be restricted within a few degrees by evaporating an organic pigment and/or an organic dye using a mask, such as a metal mask or the like, so as to wrap around from the gap of the metal mask onto the substrate. Therefore, the transparent electrode and auxiliary hard wiring formed on the color filter 2 can be reliably prevented from being cut.

Furthermore, according to this embodiment, since a patterned layer does not contain any volatile solvent and it is unnecessary to remove any volatile solvent from the layer after patterning, it is possible to prevent the surface of a color filter 2 from becoming uneven and light from being unevenly emitted and it is further possible to minimize the bad influence on electrodes or an organic light emitting layer due to the unevenness of the color filter 2.

Moreover, according to this embodiment, since the color filter 2 is formed by evaporating an organic pigment and/or an organic dye, the color filter 2 can be formed on a substrate having relatively low heat resistance such as a resin film and, therefore, it is possible to improve the degree of freedom in selecting a substrate material.

FIG. 2 is a schematic cross-sectional view showing an organic EL device which is another preferred embodiment of the present invention.

As shown in FIG. 2, an organic EL device according to this embodiment is formed by laminating a substrate 1, a color filter 2 formed by evaporating an organic pigment and/or an organic dye using a mask on the substrate 1, a fluorescence converting layer 13, a passivation layer 3, a hole injecting electrode 4, a hole injecting layer 5, a hole transporting layer 6, a first organic light emitting layer 7, a second organic light emitting layer 8, an electron transporting layer 9, an electron injecting layer 10 and an electron injecting electrode 11, in this order. The fluorescence converting layer 13 serves to convert light emitted from the first organic light emitting layer 7 and the second organic light emitting layer 8 into light having a predetermined wavelength.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, similarly to the embodiment shown in FIG. 1, light emitted from the first organic light emitting layer 7 and the second organic light emitting layer 8 is taken out via the substrate 1 and, therefore, the substrate is formed of a transparent material.

According to this embodiment, since the organic EL device further includes the fluorescence converting layer 13 for converting light emitted from the first organic light emitting layer 7 and the second organic light emitting layer 8 into light having a predetermined wavelength, it is possible to generate light components of wavelengths which are not contained in light emitted from the first organic light emitting layer 7 and the second organic light emitting layer 8 or to compensate light with a light emitted from the first organic light emitting layer 7 and the second organic light emitting layer 8 with light components of wavelengths which are not sufficiently contained therein.

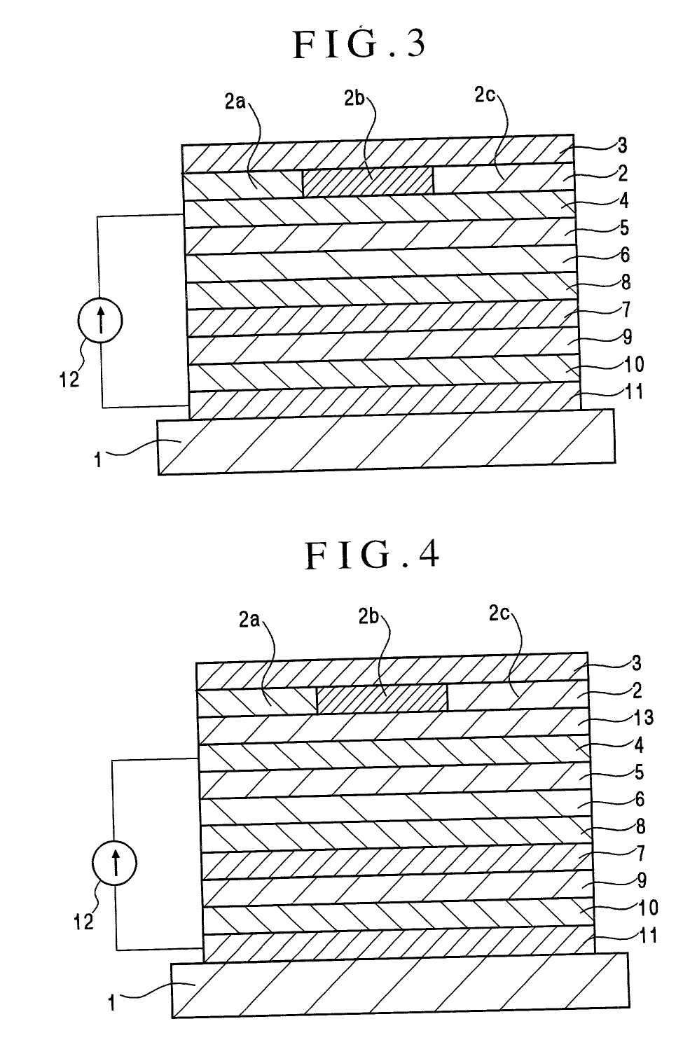

FIG. 3 is a schematic cross-sectional view showing an organic EL device which is a further preferred embodiment of the present invention.

As shown in FIG. 3, an organic EL device according to this embodiment is formed by laminating a substrate 1, an electron injecting electrode 11, an electron injecting layer 10, electron transporting layer 9, a first organic light emitting layer 7, a second organic light emitting layer 8, a hole transporting layer 6, a hole transporting layer 5, a hole injecting electrode 4, a color filter 2 formed by evaporating an organic pigment and/or an organic dye using a mask on the substrate 1 and a passivation layer 3, in this order.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out on the side opposite to the substrate 1. Therefore, the substrate 1 need not be formed of a transparent material.

FIG. 4 is a schematic cross-sectional view showing an organic EL device which is a further preferred embodiment of the present invention.

As shown in FIG. 4, an organic EL device according to this embodiment is formed by laminating a substrate 1, an electron injecting electrode 11, an electron injecting layer 10, electron transporting layer 9, a first organic light emitting layer 7, a second organic light emitting layer 8, a hole transporting layer 6, a hole transporting layer 5, a hole injecting electrode 4, a fluorescence converting layer 13, a color filter 2 formed by evaporating an organic pigment and/or an organic dye using a mask on the substrate 1 and a passivation layer 3, in this order. The fluorescence converting layer 13 serves to convert light emitted from the first organic light emitting layer 7 and the second organic light emitting layer 8 into light having a predetermined wavelength.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out on the side opposite to the substrate 1. Therefore, the substrate 1 need not be formed of a transparent material.

According to this embodiment, since the organic EL device further includes the fluorescence converting layer 13 for converting light emitted from the first organic light emitting layer 7 and the second organic light emitting layer 8 into light having a predetermined wavelength, it is possible to generate light components of wavelengths which are not contained in light emitted from the first organic light emitting layer 7 and the second organic light emitting layer 8 or to compensate light with a light emitted from the first organic light emitting layer 7 and the second organic light emitting layer 8 with light components of wavelengths which are not sufficiently contained therein.

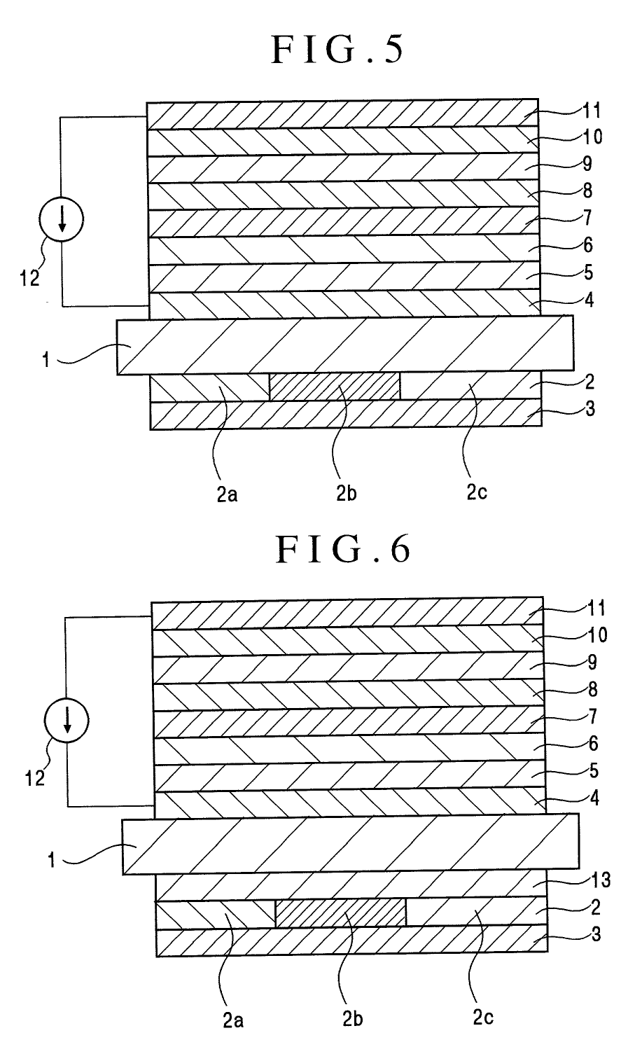

FIG. 5 is a schematic cross-sectional view showing an organic EL device which is a further preferred embodiment of the present invention.

As shown in FIG. 5, an organic EL device according to this embodiment comprises a substrate 1, a color filter 2 formed by evaporating an organic pigment and/or an organic dye using a mask and a passivation layer 3 laminated in this order on one surface of the substrate 1, and a hole injecting electrode 4, a hole injecting layer 5, a hole transporting layer 6, a first organic light emitting layer 7, a second organic light emitting layer 8, an electron transporting layer 9, an electron injecting layer 10 and an electron injecting electrode 11 laminated in this order on the other surface of the substrate 1.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out via the substrate 1, the color filter 2 and the passivation layer 3. Therefore, the substrate 1 is formed of a transparent material.

FIG. 6 is a schematic cross-sectional view showing an organic EL device which is a further preferred embodiment of the present invention.

As shown in FIG. 6, an organic EL device according to this embodiment comprises a substrate 1, a fluorescence converting layer 13, a color filter 2 formed by evaporating an organic pigment and/or an organic dye using a mask and a passivation layer 3 laminated in this order on one surface of the substrate 1, and a hole injecting electrode 4, a hole injecting layer 5, a hole transporting layer 6, a first organic light emitting layer 7, a second organic light emitting layer 8, an electron transporting layer 9, an electron injecting layer 10 and an electron injecting electrode 11 laminated in this order on the other surface of the substrate 1. The fluorescence converting layer 13 serves to convert light emitted from the first organic light emitting layer 7 and the second organic light emitting layer 8 into light having a predetermined wavelength.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out via the substrate 1, the fluorescence converting layer 13, the color filter 2 and the passivation layer 3. Therefore, the substrate 1 is formed of a transparent material.

According to this embodiment, since the organic EL device further includes the fluorescence converting layer 13 for converting light emitted from the first organic light emitting layer 7 and the second organic light emitting layer 8 into light having a predetermined wavelength, it is possible to generate light components of wavelengths which are not contained in light emitted from the first organic light emitting layer 7 and the second organic light emitting layer 8 or to compensate light with a light emitted from the first organic light emitting layer 7 and the second organic light emitting layer 8 with light components of wavelengths which are not sufficiently contained therein.

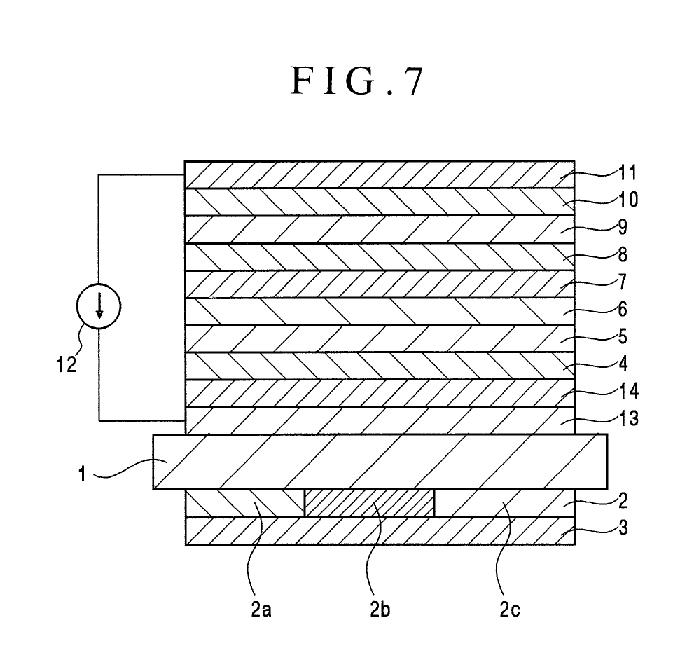

FIG. 7 is a schematic cross-sectional view showing an organic EL device which is a further preferred embodiment of the present invention.

As shown in FIG. 7, an organic EL device according to this embodiment comprises a substrate 1, a color filter 2 formed by evaporating an organic pigment and/or an organic dye using a mask and a passivation layer 3 laminated in this order on one surface of the substrate 1, and a fluorescence converting layer 13, a passivation layer 14, a hole injecting electrode 4, a hole injecting layer 5, a hole transporting layer 6, a first organic light emitting layer 7, a second organic light emitting layer 8, an electron transporting layer 9, an electron injecting layer 10 and an electron injecting electrode 11 laminated in this order on the other surface of the substrate 1. The fluorescence converting layer 13 serves to convert light emitted from the first organic light emitting layer 7 and the second organic light emitting layer 8 into light having a predetermined wavelength and emit it toward the substrate 1.

A driving electric source 12 is connected between the hole injecting electrode 4 and the electron injecting electrode 11.

In this embodiment, similarly to the embodiment shown in FIG. 1, the color filter 2 is constituted by a first color filter layer 2a, a second color filter layer 2b and a third color filter layer 2c formed next to one another. The first color filter 2a has a light transmission characteristic for transmitting light having a wavelength of 578 to 620 nm, the second color filter layer 2b has a light transmission characteristic for transmitting light having a wavelength of 520 to 570 and the third color filter 2c has a light transmission characteristic for transmitting light having a wavelength of 430 to 470 nm.

In this embodiment, light emitted from the first organic light emitting layer 7 and the second organic light emitting layer 8 is taken out via the substrate 1, the fluorescence converting layer 13, the color filter 2 and the passivation layer 3. Therefore, the substrate 1 is formed of a transparent material.

According to this embodiment, since the organic EL device further includes the fluorescence converting layer 13 for converting light emitted from the first organic light emitting layer 7 and the second organic light emitting layer 8 into light having a predetermined wavelength, it is possible to generate light components of wavelengths which are not contained in light emitted from the first organic light emitting layer 7 and the second organic light emitting layer 8 or to compensate light with a light emitted from the first organic light emitting layer 7 and the second organic light emitting layer 8 with light components of wavelengths which are not sufficiently contained therein.

### WORKING EXAMPLES AND A COMPARATIVE EXAMPLE

Hereinafter, working examples and a comparative example will be set out in order to further clarify the advantages of the present invention.

### WORKING EXAMPLE 1

A glass substrate manufactured by Corning Japan Co., Ltd. under product designation #7059 was employed as a transparent substrate and a red color pigment, a green color pigment and a blue color pigment were evaporated on the transparent substrate using a mask, thereby forming a color filter including a first color filter, a second color filter and a third color filter formed next to one another.

The first color filter corresponding to a red color filter was formed by evaporating Pigment Red 254 shown by structural formula (1) and the second color filter corresponding to a green color filter was formed by evaporating tertiary butyl titanium phthalocyanine shown by structural formula (2). The third color filter corresponding to a blue color filter was formed by evaporating monomethyl copper phthalocyanine shown by structural formula (3).

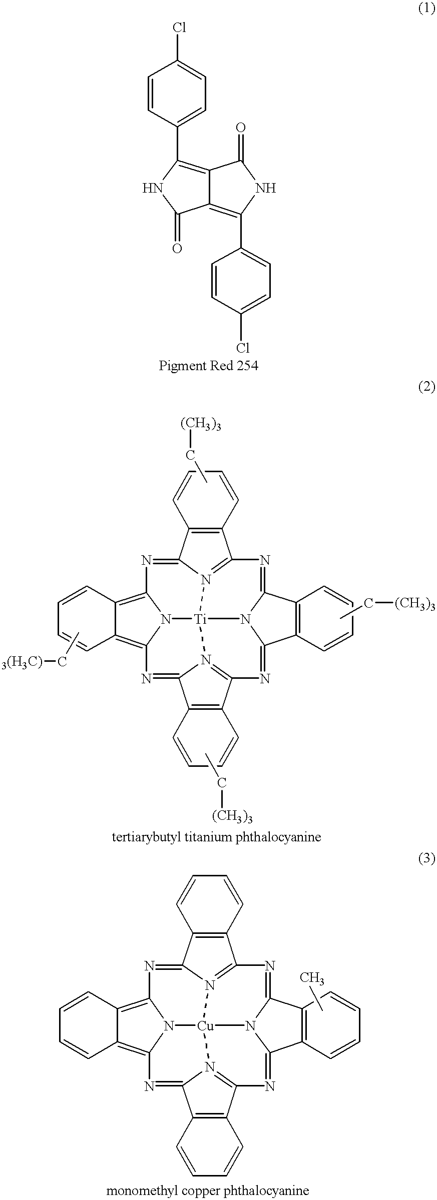

The measured thicknesses of the first color filter, the second color filter and the third color filter were 4223 angstroms, 4012 angstroms and 3694 angstroms, respectively.

After the color filter was formed, a passivation layer containing silicon oxide was formed by sputtering on the color filter and a transparent electrode (ITO electrode) layer was formed by sputtering on the passivation layer. The transparent electrode layer was then patterned.

The thus obtained layered product was washed using an ultrasonic wave and was washed using boiling ethanol. The layered product was then set in a vacuum evaporation apparatus and a hole transporting layer, an organic white light emitting layer, an electron transporting layer and a cathode were formed in this order under a vacuum of 1.33×10⁻² or less, thereby producing an organic EL display panel.

The chromaticity of red light emission, the chromaticity of green light emission and the chromaticity of blue light emission of the thus obtained organic EL display panel were measured and the results of the measurement are shown in Table 1.

TABLE 1

| | x | y |
|---|---|---|
| Red | 0.596 | 0.325 |
| Green | 0.286 | 0.572 |
| Blue | 0.117 | 0.182 |

### WORKING EXAMPLE 2

A glass substrate manufactured by Corning Japan Co., Ltd. under product designation #7059 was employed as a transparent substrate and Pigment Red 254 shown by structural formula (1) as a red color pigment, tertiary butyl titanium phthalocyanine shown by structural formula (2) as a green color pigment and monomethyl copper phthalocyanine shown by structural formula (3) as a blue color pigment were evaporated on the transparent substrate using a mask, thereby forming a color filter including a first color filter, a second color filter and a third color filter formed next to one another.

The measured thicknesses of the first color filter corresponding to a red color filter, the second color filter corresponding to a green color filter and the third color filter corresponding to a blue color filter were 485 angstroms, 612 angstroms and 396 angstroms, respectively After the color filter was formed, a passivation layer containing silicon oxide was formed by sputtering on the color filter and a transparent electrode (ITO electrode) layer was formed by sputtering on the passivation layer. The transparent electrode layer was then patterned.

The thus obtained layered product was washed using an ultrasonic wave and was washed using boiling ethanol. The layered product was then set in a vacuum evaporation apparatus and a hole transporting layer, an organic light emitting layer, an electron transporting layer and a cathode were formed in this order under a vacuum of 1.33×10⁻² or less, thereby producing an organic EL display panel. The organic light emitting layer was formed by evaporating an organic compound for emitting red light in a region corresponding to the first color filter, evaporating an organic compound for emitting green light in a region corresponding to the second color filter and evaporating an organic compound for emitting blue light in a region corresponding to the third color filter.

The chromaticity of red light emission, the chromaticity of green light emission and the chromaticity of blue light emission of the thus obtained organic EL display panel were measured and the results of the measurement are shown in Table 2.

TABLE 2

| | x | y |
|---|---|---|
| Red | 0.662 | 0.327 |
| Green | 0.211 | 0.654 |
| Blue | 0.136 | 0.121 |

### COMPARATIVE EXAMPLE

A glass substrate manufactured by Corning Japan Co., Ltd. under product designation #7059 was employed as a transparent substrate and red color resist for liquid crystal (manufactured by Fuji Film Aurene Co., Ltd. under product designation CR7001), green color resist for liquid crystal (manufactured by Fuji Film Aurene Co., Ltd. under product designation CG7001) and blue color resist for liquid crystal (manufactured by Fuji Film Aurene Co., Ltd. under product designation CB7001) were patterned on the transparent substrate so that the thickness of each was 1.5 μm, thereby forming a color filter including a first color filter, a second color filter and a third color filter formed next to one another. Further, an overcoat layer was formed on the thus formed color filter by patterning CT manufactured by Fuji Film Aurene Co., Ltd.

After the color filter and the overcoat layer were formed on the transparent substrate, a passivation layer containing silicon oxide was formed by sputtering on the color filter and a transparent electrode (ITO electrode) layer was formed by sputtering on the passivation layer. The transparent electrode layer was then patterned.

The thus obtained layered product was washed using an ultrasonic wave and was washed using boiling ethanol. The layer product was then set in a vacuum evaporation apparatus and a hole transporting layer, an organic white light emitting layer, an electron transporting layer and a cathode were formed in this order under a vacuum of 1.33×10⁻² or less, thereby producing an organic EL display panel.

The chromaticity of red light emission, the chromaticity of green light emission and the chromaticity of blue light emission of the thus obtained organic EL display panel were measured and the results of the measurement are shown in Table 3.

TABLE 3

| | x | y |
|---|---|---|
| Red | 0.632 | 0.355 |
| Green | 0.227 | 0.567 |
| Blue | 0.125 | 0.152 |

As apparent from the comparison of Table 1, Table 2 and Table 3, it was found from experimental results that the color filters according to Working Example 1 and Working Example 2 prepared using the present invention had color purity comparable to or better than the color filter according to Comparative Example prepared using a photo-lithographic process. Therefore, despite of the fact that color purity generally decreases as a color filter becomes thinner, it was found that in the present invention, even though the color filters had only a quarter of the thickness of the color filter of Comparative Example prepared using a photo-lithographic process, they exhibited color purity comparable to or better than the color filter of Comparative Example prepared using a photo-lithographic process and that it was possible to produce an organic EL device which could be made considerably thinner at a low cost and exhibited excellent properties.

The present invention has thus been shown and described with reference to specific embodiments and working examples. However, it should be noted that the present invention is in no way limited to the details of the described arrangements and examples but changes and modifications may be made without departing from the scope of the appended claims.

For example, in the embodiments described in FIGS. 1 to 7, the color filter 2 is formed by evaporating an organic pigment and/or an organic dye using a mask. However, the color filter 2 may be formed by evaporating an inorganic pigment instead of an organic pigment and/or an organic dye and the color filter 2 may be formed by evaporating two or more kinds of organic pigments, two or more kinds of organic dyes, two or more kinds of inorganic pigments, two or more kinds of organic pigments and two or more kinds of organic dyes, or two or more kinds of inorganic pigments and two or more kinds of organic dyes, using a mask.

Further, in the embodiments described in FIGS. 1 to 7, although the color filter 2 is formed by evaporating an organic pigment and/or an organic dye using a mask, it is sufficient to form a color filter by evaporating an organic pigment and/or an organic dye and it is not absolutely necessary to use a mask.

Furthermore, the color filter 2 is formed on the substrate 1 in the embodiments shown in FIGS. 1 and 2, the color filter 2 is formed on the hole injecting electrode 4 in the embodiments shown in FIGS. 3 and 4, the color filter 2 is formed on the substrate 1 on the side opposite to the first organic light emitting layer 7 and the second organic light emitting layer 8 in the embodiments shown in FIGS. 5 and 7, and the color filter 2 is formed on the fluorescence converting layer 13 in the embodiment shown in FIG. 6. However, it is sufficient for the organic EL device to have a color filter 2 and the position of the color filter 2 can be arbitrarily determined.

Moreover, in the embodiments described in FIGS. 1 to 7, although each of the organic EL devices includes the first organic light emitting layer 7 and the second organic light emitting layer 8, it is not absolutely necessary for the organic EL device to include two organic light emitting layers and the organic EL device may include a single organic light emitting layer or three or more organic light emitting layers.

Further, in the embodiments described in FIGS. 1 to 7, although each of the organic EL devices includes the hole injecting layer 5 and the hole transporting layer 6, the hole injecting layer 5 and the hole transporting layer 6 can be replaced by a single hole injecting and transporting layer having the functions of both the hole injecting layer 5 and the hole transporting layer 6.

Furthermore, in the embodiments described in FIGS. 1 to 7, each of the organic EL devices includes the hole injecting layer 5 formed of an organic material and the hole transporting layer 6 formed of an organic material. However, instead of these layers or in addition to these layers, it is possible to provide an inorganic hole injecting and transporting layer having a high resistance and formed of an inorganic material.

Moreover, in the embodiments described in FIGS. 1 to 7, although each of the organic EL devices includes the electron transporting layer 9 and the electron injecting layer 10, the electron transporting layer 9 and the electron injecting layer 10 can be replaced by a single electron injecting and transporting layer having the functions of both the electron transporting layer 9 and the electron injecting layer 10.

Further, in the embodiments described in FIGS. 1 to 7, each of the organic EL devices includes the electron transporting layer 9 and the electron injecting layer 10. However, instead of these layers or in addition these layers, it is possible to provide an inorganic electron injecting and transporting layer having a high resistance and formed by an inorganic material.

According to the present invention, it is possible to provide an organic EL display panel and an organic EL device therefor which can be manufactured at low cost and made thinner, and has excellent properties.

1. An organic EL display panel comprising a substrate, at least one organic light emitting layer between two electrodes, at least one of which is transparent, and a color filter layer formed by evaporating a pigment and/or an organic dye, the organic EL display panel being divided into a plurality of organic EL devices capable of being independently controlled.

2. An organic EL display panel in accordance with claim 1, wherein the color filter layer is of a thickness equal to or less than 1.5 micrometer.

3. An organic EL display panel in accordance with claim 1, which further includes a passivation layer on the surface of the color filter layer.

4. An organic EL display panel in accordance with claim 1, which further includes a fluorescence converting layer formed by evaporating a fluorescent substance on the side of the color filter layer opposite to the side from which light is to be taken out and adapted for converting light emitted from the at least one organic light emitting layer into light having a predetermined wavelength.

5. An organic EL display panel in accordance with claim 3, which further includes a fluorescence converting layer formed by evaporating a fluorescent substance on the side of the color filter layer opposite to the side from which light is to be taken out and adapted for converting light emitted from the at least one organic light emitting layer into light having a predetermined wavelength.

6. An organic EL display panel in accordance with claim 4, which further includes a passivation layer on the fluorescence converting layer and/or the color filter layer.

7. An organic EL display panel in accordance with claim 5, which further includes a passivation layer on the fluorescence converting layer and/or the color filter layer.

8. An organic EL display panel in accordance with claim 3, wherein the passivation layer is formed of a silicon compound.

9. An organic EL display panel in accordance with claim 6, wherein the passivation layer is formed of a silicon compound.

10. An organic EL display panel in accordance with claim 7, wherein the passivation layer is formed of a silicon compound.

11. An organic EL device comprising a substrate, at least one organic light emitting layer between two electrodes, at least one of which is transparent, and a color filter formed by evaporating a pigment and/or an organic dye.

12. An organic EL device in accordance with claim 11, wherein the color filter is of a thickness equal to or less than 1.5 micrometer.

13. An organic EL device in accordance with claim 11, wherein the color filter further includes a first color filter, a second color filter and a third color filter form next to one another, the first color filter having a light transmission characteristic for transmitting light having a wavelength of 573 to 780 nm, the second color filter having a light transmission characteristic for transmitting light having a wavelength of 493 to 573 nm and the third color filter having a light transmission characteristic for transmitting light having a wavelength of 380 to 493 nm.

14. An organic EL device in accordance with claim 11, wherein the at least one organic light emitting layer is formed of an organic light emitting layer for emitting white light having a continuous spectrum in at least a wavelength range of 380 to 780 nm.

15. An organic EL device in accordance with claim 13, wherein the at least one organic light emitting layer is formed of an organic light emitting layer for emitting white light having a continuous spectrum in at least a wavelength range of 380 to 780 nm.

16. An organic EL device in accordance with claim 11, which further includes a passivation layer on the color filter.

17. An organic EL device in accordance with claim 13, which further includes a passivation layer on the color filter.

18. An organic EL device in accordance with claim 14, which further includes a passivation layer on the color filter.

19. An organic EL device in accordance with claim 15, which further includes a passivation layer on the color filter.

20. An organic EL device in accordance with claim 11, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

21. An organic EL device in accordance with claim 13, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

22. An organic EL device in accordance with claim 14, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

23. An organic EL device in accordance with claim 15, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

24. An organic EL device in accordance with claim 16, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

25. An organic EL device in accordance with claim 17, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

26. An organic EL device in accordance with claim 18, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

27. An organic EL device in accordance with claim 19, which further includes a fluorescence converting layer formed by evaporating a fluorescent substance on the side of the color filter opposite to the side from which light is to be taken out and adapted for converting light emitted from the at least one organic light emitting layer into light having a predetermined wavelength.

28. An organic EL device in accordance with claim 20, which further includes a passivation layer on a surface of the fluorescence converting layer and/or the color filter.

29. An organic EL device in accordance with claim 21, which further includes a passivation layer on a surface of the fluorescence converting layer and/or the color filter.

30. An organic EL device in accordance with claim 22, which further includes a passivation layer on a surface of the fluorescence converting layer and/or the color filter.

31. An organic EL device in accordance with claim 23, which further includes a passivation layer on a surface of the fluorescence converting layer and/or the color filter.

32. An organic EL device in accordance with claim 24, which further includes a passivation layer on a surface of the fluorescence converting layer and/or the color filter.

33. An organic EL device in accordance with claim 25, which further includes a passivation layer on a surface of the fluorescence converting layer and/or the color filter.

34. An organic EL device in accordance with claim 26, which further includes a passivation layer on a surface of the fluorescence converting layer and/or the color filter.

35. An organic EL device in accordance with claim 27, which further includes a passivation layer on a surface of the fluorescence converting layer and/or the color filter.

36. An organic EL device in accordance with claim 16, wherein the passivation layer is formed of a silicon compound.

37. An organic EL device in accordance with claim 17, wherein the passivation layer is formed of a silicon compound.

38. An organic EL device in accordance with claim 18, wherein the passivation layer is formed of a silicon compound.

39. An organic EL device in accordance with claim 19, wherein the passivation layer is formed of a silicon compound.

40. An organic EL device in accordance with claim 28, wherein the passivation layer is formed of a silicon compound.

41. An organic EL device in accordance with claim 29, wherein the passivation layer is formed of a silicon compound.

42. An organic EL device in accordance with claim 30, wherein the passivation layer is formed of a silicon compound.

43. An organic EL device in accordance with claim 31, wherein the passivation layer is formed of a silicon compound.

44. An organic EL device in accordance with claim 32, wherein the passivation layer is formed of a silicon compound.

45. An organic EL device in accordance with claim 33, wherein the passivation layer is formed of a silicon compound.

46. An organic EL device in accordance with claim 34, wherein the passivation layer is formed of a silicon compound.

47. An organic EL device in accordance with claim 35, wherein the passivation layer is formed of a silicon compound.
